(19) United States
(12) Patent Application Publication
(10) Pub. No.: US 2023/0325645 A1
(43) Pub. Date: Oct. 12, 2023

(54) ARTIFICIAL NEURAL NETWORK COMPRISING A THREE-DIMENSIONAL INTEGRATED CIRCUIT

(71) Applicant: Silicon Storage Technology, Inc., San Jose, CA (US)

(72) Inventors: Hieu Van Tran, San Jose, CA (US); Mark Reiten, Alamo, CA (US); Nhan Do, Saratoga, CA (US)

(21) Appl. No.: 17/848,371

(22) Filed: Jun. 23, 2022

Related U.S. Application Data
(60) Provisional application No. 63/328,126, filed on Apr. 6, 2022.

(51) Int. Cl. G06N 3/063; G06F 17/16

(52) U.S. Cl. CPC G06N 3/063; G06F 17/16

(57) ABSTRACT

Numerous examples are disclosed of an artificial neural network comprising a three-dimensional integrated circuit. In one embodiment, a three-dimensional integrated circuit for use in an artificial neural network comprises a first die comprising a first vector by matrix multiplication array and a first input multiplexor, the first die located on a first vertical layer; a second die comprising an input circuit, the second die located on a second vertical layer different than the first vertical layer; and one or more vertical interfaces coupling the first die and the second die; wherein during a read operation, the input circuit provides an input signal to the first input multiplexor over at least one of the one or more vertical interfaces, the first input multiplexor applies the input signal to one or more rows in the first vector by matrix multiplication array, and the first vector by matrix multiplication array generates an output.

### PRIORITY CLAIM

This application claims priority to U.S. Provisional Patent Application No. 63/328,126, filed on Apr. 6, 2022, and titled, “Artificial Neural Network Comprising a Three-Dimensional Integrated Circuit,” which is incorporated by reference herein.

### FIELD OF THE INVENTION

Numerous examples are disclosed of an artificial neural network comprising a three-dimensional integrated circuit.

### BACKGROUND OF THE INVENTION

Artificial neural networks mimic biological neural networks (the central nervous systems of animals, in particular the brain) and are used to estimate or approximate functions that can depend on a large number of inputs and are generally unknown. Artificial neural networks generally include layers of interconnected “neurons” which exchange messages between each other.

FIG. 1 illustrates an artificial neural network, where the circles represent the inputs or layers of neurons. The connections (called synapses) are represented by arrows and have numeric weights that can be tuned based on experience. This makes neural networks adaptive to inputs and capable of learning. Typically, neural networks include a layer of multiple inputs. There are typically one or more intermediate layers of neurons, and an output layer of neurons that provide the output of the neural network. The neurons at each level individually or collectively make a decision based on the received data from the synapses.

One of the major challenges in the development of artificial neural networks for high-performance information processing is a lack of adequate hardware technology. Indeed, practical neural networks rely on a very large number of synapses, enabling high connectivity between neurons, i.e., a very high computational parallelism. In principle, such complexity can be achieved with digital supercomputers or specialized graphics processing unit clusters. However, in addition to high cost, these approaches also suffer from mediocre energy efficiency as compared to biological networks, which consume much less energy primarily because they perform low-precision analog computation. CMOS analog circuits have been used for artificial neural networks, but most CMOS-implemented synapses have been too bulky given the high number of neurons and synapses.

Applicant previously disclosed an artificial (analog) neural network that utilizes one or more non-volatile memory arrays as the synapses in U.S. Patent Application Publication 2017/0337466A1, which is incorporated by reference. The non-volatile memory arrays operate as an analog neural memory and comprise non-volatile memory cells arranged in rows and columns. The neural network includes a first plurality of synapses configured to receive a first plurality of inputs and to generate therefrom a first plurality of outputs, and a first plurality of neurons configured to receive the first plurality of outputs. The first plurality of synapses includes a plurality of memory cells, wherein each of the memory cells includes spaced apart source and drain regions formed in a semiconductor substrate with a channel region extending there between, a floating gate disposed over and insulated from a first portion of the channel region and a non-floating gate disposed over and insulated from a second portion of the channel region. Each of the plurality of memory cells store a weight value corresponding to a number of electrons on the floating gate. The plurality of memory cells multiply the first plurality of inputs by the stored weight values to generate the first plurality of outputs.

### Non-Volatile Memory Cells

Non-volatile memories are well known. For example, U.S. Pat. No. 5,029,130 (“the '130 patent”), which is incorporated herein by reference, discloses an array of split gate non-volatile memory cells, which are a type of flash memory cells. Such a memory cell 210 is shown in FIG. 2. Each memory cell 210 includes source region 14 and drain region 16 formed in semiconductor substrate 12, with channel region 18 there between. Floating gate 20 is formed over and insulated from (and controls the conductivity of) a first portion of the channel region 18, and over a portion of the source region 14. Word line terminal 22 (which is typically coupled to a word line) has a first portion that is disposed over and insulated from (and controls the conductivity of) a second portion of the channel region 18, and a second portion that extends up and over the floating gate 20. The floating gate 20 and word line terminal 22 are insulated from the substrate 12 by a gate oxide. Bitline 24 is coupled to drain region 16.

Memory cell 210 is erased (where electrons are removed from the floating gate) by placing a high positive voltage on the word line terminal 22, which causes electrons on the floating gate 20 to tunnel through the intermediate insulation from the floating gate 20 to the word line terminal 22 via Fowler-Nordheim (FN) tunneling.

Memory cell 210 is programmed by source side injection (SSI) with hot electrons (where electrons are placed on the floating gate) by placing a positive voltage on the word line terminal 22,and a positive voltage on the source region 14. Electron current will flow from the drain region 16 towards the source region 14. The electrons will accelerate and become heated when they reach the gap between the word line terminal 22 and the floating gate 20. Some of the heated electrons will be injected through the gate oxide onto the floating gate 20 due to the attractive electrostatic force from the floating gate 20.

Memory cell 210 is read by placing positive read voltages on the drain region 16 and word line terminal 22 (which turns on the portion of the channel region 18 under the word line terminal). If the floating gate 20 is positively charged (i.e., erased of electrons), then the portion of the channel region 18 under the floating gate 20 is turned on as well, and current will flow across the channel region 18, which is sensed as the erased or “1” state. If the floating gate 20 is negatively charged (i.e., programmed with electrons), then the portion of the channel region under the floating gate 20 is mostly or entirely turned off, and current will not flow (or there will be little flow) across the channel region 18, which is sensed as the programmed or “0” state.

Table No. 1 depicts typical voltage and current ranges that can be applied to the terminals of memory cell 210 for performing read, erase, and program operations:

TABLE NO. 1
Operation of Flash Memory Cell 210 of FIG. 2

| | | |
|---|---|---|
| WL | BL | SL |

| | | | | | | |
|---|---|---|---|---|---|---|
| Read | 2-3 | V | 0.6-2 | V | 0 | V |
| Erase | ~11-13 | V | 0 | V | 0 | V |
| Program | 1-2 | V | 10.5-3 | μA | 9-10 | V |

Other split gate memory cell configurations, which are other types of flash memory cells, are known. For example, FIG. 3 depicts a four-gate memory cell 310 comprising source region 14, drain region 16, floating gate 20 over a first portion of channel region 18, a select gate 22 (typically coupled to a word line, WL) over a second portion of the channel region 18, a control gate 28 over the floating gate 20, and an erase gate 30 over the source region 14. This configuration is described in U.S. Pat. No. 6,747,310, which is incorporated herein by reference for all purposes. Here, all gates are non-floating gates except floating gate 20, meaning that they are electrically connected or connectable to a voltage source. Programming is performed by heated electrons from the channel region 18 injecting themselves onto the floating gate 20. Erasing is performed by electrons tunneling from the floating gate 20 to the erase gate 30.

Table No. 2 depicts typical voltage and current ranges that can be applied to the terminals of memory cell 310 for performing read, erase, and program operations:

TABLE NO. 2
Operation of Flash Memory Cell 310 of FIG. 3

| | WL/SG | | BL | | CG | EG | | SL | |
|---|---|---|---|---|---|---|---|---|---|
| Read | 1.0-2 | V | 0.6-2 | V | 0-2.6 V | 0-2.6 | V | 0 | V |
| Erase | −0.5 V/0 V | | 0 | V | 0 V/−8 V | 8-12 | V | 0 | V |
| Program | 1 | V | 0.1-1 | μA | 8-11 V | 4.5-9 | V | 4.5-5 | V |

FIG. 4 depicts a three-gate memory cell 410, which is another type of flash memory cell. Memory cell 410 is identical to the memory cell 310 of FIG. 3 except that memory cell 410 does not have a separate control gate. The erase operation (whereby erasing occurs through use of the erase gate) and read operation are similar to that of the FIG. 3 except there is no control gate bias applied. The programming operation also is done without the control gate bias, and as a result, a higher voltage is applied on the source line during a program operation to compensate for a lack of control gate bias.

Table No. 3 depicts typical voltage and current ranges that can be applied to the terminals of memory cell 410 for performing read, erase, and program operations:

TABLE NO. 3
Operation of Flash Memory Cell 410 of FIG. 4

| | | | |
|---|---|---|---|
| WL/SG | BL | EG | SL |

| | | | | | | | |
|---|---|---|---|---|---|---|---|
| Read | 0.7-2.2 | V | 0.6-2 | V | 0-2.6 | V | 0 V |

| | | | | | | |
|---|---|---|---|---|---|---|
| Erase | −0.5 V/0 V | 0 | V | 11.5 | V | 0 V |

| | | | | | | | |
|---|---|---|---|---|---|---|---|
| Program | 1 | V | 0.2-3 | μA | 4.5 | V | 7-9 V |

FIG. 5 depicts stacked gate memory cell 510, which is another type of flash memory cell. Memory cell 510 is similar to memory cell 210 of FIG. 2, except that floating gate 20 extends over the entire channel region 18, and control gate 22 (which here will be coupled to a word line) extends over floating gate 20, separated by an insulating layer (not shown). The erase is done by FN tunneling of electrons from FG to substrate, programming is by channel hot electron (CHE) injection at region between the channel 18 and the drain region 16, by the electrons flowing from the source region 14 towards to drain region 16 and read operation which is similar to that for memory cell 210 with a higher control gate voltage.

Table No. 4 depicts typical voltage ranges that can be applied to the terminals of memory cell 510 and substrate 12 for performing read, erase, and program operations:

TABLE NO. 4
Operation of Flash Memory Cell 510 of FIG. 5

| | CG | BL | SL | Substrate |
|---|---|---|---|---|
| Read | 2-5 V | 0.6-2 V | 0 V | 0 V |
| Erase | −8 to −10 V/0 V | FLT | FLT | 8-10 V/15-20 V |
| Program | 8-12 V | 3-5 V | 0 V | 0 V |

The methods and means described herein may apply to other non-volatile memory technologies such as FINFET split gate flash or stack gate flash memory, NAND flash, SONOS (silicon-oxide-nitride-oxide-silicon, charge trap in nitride), MONOS (metal-oxide-nitride-oxide-silicon, metal charge trap in nitride), ReRAM (resistive random access memory), PCM (phase change memory), MRAM (magnetic ram), FeRAM (ferroelectric ram), CT (charge trap) memory, CN (carbon-tube) memory, OTP (bi-level or multi-level one time programmable), and CeRAM (correlated electron ram), without limitation.

In order to utilize the memory arrays comprising one of the types of non-volatile memory cells described above in an artificial neural network, two modifications are made. First, the lines are configured so that each memory cell can be individually programmed, erased, and read without adversely affecting the memory state of other memory cells in the array, as further explained below. Second, continuous (analog) programming of the memory cells is provided.

Specifically, the memory state (i.e., charge on the floating gate) of each memory cell in the array can be continuously changed from a fully erased state to a fully programmed state, and vice-versa, independently and with minimal disturbance of other memory cells. This means the cell storage is effectively analog or at the very least can store one of many discrete values (such as 16 or 64 different values), which allows for very precise and individual tuning of all the memory cells in the memory array, and which makes the memory array ideal for storing and making fine tuning adjustments to the synapsis weights of the neural network.

### Neural Networks Employing Non-Volatile Memory Cell Arrays

FIG. 6 conceptually illustrates a non-limiting example of a neural network utilizing a non-volatile memory array of the present examples. This example uses the non-volatile memory array neural network for a facial recognition application, but any other appropriate application could be implemented using a non-volatile memory array based neural network.

S0 is the input layer, which for this example is a 32×32 pixel RGB image with 5 bit precision (i.e. three 32×32 pixel arrays, one for each color R, G and B, each pixel being 5 bit precision). The synapses CB1 going from input layer SO to layer C1 apply different sets of weights in some instances and shared weights in other instances and scan the input image with 3×3 pixel overlapping filters (kernel), shifting the filter by 1 pixel (or more than 1 pixel as dictated by the model). Specifically, values for 9 pixels in a 3×3 portion of the image (i.e., referred to as a filter or kernel) are provided to the synapses CB1, where these 9 input values are multiplied by the appropriate weights and, after summing the outputs of that multiplication, a single output value is determined and provided by a first synapse of CB1 for generating a pixel of one of the feature maps of layer C1. The 3×3 filter is then shifted one pixel to the right within input layer S0 (i.e., adding the column of three pixels on the right, and dropping the column of three pixels on the left), whereby the 9 pixel values in this newly positioned filter are provided to the synapses CB1, where they are multiplied by the same weights and a second single output value is determined by the associated synapse. This process is continued until the 3×3 filter scans across the entire 32×32 pixel image of input layer S0, for all three colors and for all bits (precision values). The process is then repeated using different sets of weights to generate a different feature map of layer C1, until all the features maps of layer C1 have been calculated.

In layer C1, in the present example, there are 16 feature maps, with 30×30 pixels each. Each pixel is a new feature pixel extracted from multiplying the inputs and kernel, and therefore each feature map is a two dimensional array, and thus in this example layer C1 constitutes 16 layers of two dimensional arrays (keeping in mind that the layers and arrays referenced herein are logical relationships, not necessarily physical relationships—i.e., the arrays are not necessarily oriented in physical two dimensional arrays). Each of the 16 feature maps in layer C1 is generated by one of sixteen different sets of synapse weights applied to the filter scans. The C1 feature maps could all be directed to different aspects of the same image feature, such as boundary identification. For example, the first map (generated using a first weight set, shared for all scans used to generate this first map) could identify circular edges, the second map (generated using a second weight set different from the first weight set) could identify rectangular edges, or the aspect ratio of certain features, and so on.

An activation function P1 (pooling) is applied before going from layer C1 to layer S1, which pools values from consecutive, non-overlapping 2×2 regions in each feature map. The purpose of the pooling function P1 is to average out the nearby location (or a max function can also be used), to reduce the dependence of the edge location for example and to reduce the data size before going to the next stage. At layer S1, there are 16 15×15 feature maps (i.e., sixteen different arrays of 15×15 pixels each). The synapses CB2 going from layer S1 to layer C2 scan maps in layer S1 with 4×4 filters, with a filter shift of 1 pixel. At layer C2, there are 22 12x12 feature maps. An activation function P2 (pooling) is applied before going from layer C2 to layer S2, which pools values from consecutive non-overlapping 2×2 regions in each feature map. At layer S2, there are 22 6×6 feature maps. An activation function (pooling) is applied at the synapses CB3 going from layer S2 to layer C3, where every neuron in layer C3 connects to every map in layer S2 via a respective synapse of CB3. At layer C3, there are 64 neurons. The synapses CB4 going from layer C3 to the output layer S3 fully connects C3 to S3, i.e. every neuron in layer C3 is connected to every neuron in layer S3. The output at S3 includes 10 neurons, where the highest output neuron determines the class. This output could, for example, be indicative of an identification or classification of the contents of the original image.

Each layer of synapses is implemented using an array, or a portion of an array, of non-volatile memory cells.

FIG. 7 is a block diagram of an array that can be used for that purpose. Vector-by-matrix multiplication (VMM) array 32 includes non-volatile memory cells and is utilized as the synapses (such as CB1, CB2, CB3, and CB4 in FIG. 6) between one layer and the next layer. Specifically, VMM array 32 includes an array of non-volatile memory cells 33, erase gate and word line gate decoder 34, control gate decoder 35, bit line decoder 36 and source line decoder 37, which decode the respective inputs for the non-volatile memory cell array 33. Input to VMM array 32 can be from the erase gate and wordline gate decoder 34 or from the control gate decoder 35. Source line decoder 37 in this example also decodes the output of the non-volatile memory cell array 33. Alternatively, bit line decoder 36 can decode the output of the non-volatile memory cell array 33.

Non-volatile memory cell array 33 serves two purposes. First, it stores the weights that will be used by the VMM array 32. Second, the non-volatile memory cell array 33 effectively multiplies the inputs by the weights stored in the non-volatile memory cell array 33 and adds them up per output line (source line or bit line) to produce the output, which will be the input to the next layer or input to the final layer. By performing the multiplication and addition function, the non-volatile memory cell array 33 negates the need for separate multiplication and addition logic circuits and is also power efficient due to its in-situ memory computation.

The output of non-volatile memory cell array 33 is supplied to a differential summer (such as a summing op-amp or a summing current mirror) 38, which sums up the outputs of the non-volatile memory cell array 33 to create a single value for that convolution. The differential summer 38 is arranged to perform summation of positive weight and negative weight.

The summed-up output values of differential summer 38 are then supplied to an activation function block 39, which rectifies the output. The activation function block 39 may provide sigmoid, tanh, or ReLU functions. The rectified output values of activation function block 39 become an element of a feature map as the next layer (e.g. C1 in FIG. 6), and are then applied to the next synapse to produce the next feature map layer or final layer. Therefore, in this example, non-volatile memory cell array 33 constitutes a plurality of synapses (which receive their inputs from the prior layer of neurons or from an input layer such as an image database), and summing op-amp 38 and activation function block 39 constitute a plurality of neurons.

The input to VMM array 32 in FIG. 7 (WLx, EGx, CGx, and optionally BLx and SLx) can be analog level, binary level, or digital bits (in which case a DAC is provided to convert digital bits to appropriate input analog level) and the output can be analog level, binary level, or digital bits (in which case an output ADC is provided to convert output analog level into digital bits).

FIG. 8 is a block diagram depicting the usage of numerous layers of VMM arrays 32, here labeled as VMM arrays 32a, 32b, 32c, 32d, and 32e. As shown in FIG. 8, the input, denoted Inputx, is converted from digital to analog by a digital-to-analog converter 31 and provided to input VMM array 32a. The converted analog inputs could be voltage or current. The input D/A conversion for the first layer could be done by using a function or a LUT (look up table) that maps the inputs Inputx to appropriate analog levels for the matrix multiplier of input VMM array 32a. The input conversion could also be done by an analog to analog (A/A) converter to convert an external analog input to a mapped analog input to the input VMM array 32a.

The output generated by input VMM array 32a is provided as an input to the next VMM array (hidden level 1) 32b, which in turn generates an output that is provided as an input to the next VMM array (hidden level 2) 32c, and so on. The various layers of VMM array 32 function as different layers of synapses and neurons of a convolutional neural network (CNN). Each VMM array 32a, 32b, 32c, 32d, and 32e can be a stand-alone, physical non-volatile memory array, or multiple VMM arrays could utilize different portions of the same physical non-volatile memory array, or multiple VMM arrays could utilize overlapping portions of the same physical non-volatile memory array. The example shown in FIG. 8 contains five layers (32a,32b,32c,32d,32e): one input layer (32a), two hidden layers (32b,32c), and two fully connected layers (32d,32e). One of ordinary skill in the art will appreciate that this is merely an example and that a system instead could comprise more than two hidden layers and more than two fully connected layers.

### Vector-by-Matrix Multiplication (VMM) Arrays

FIG. 9 depicts neuron VMM array 900, which is particularly suited for memory cells 310 as shown in FIG. 3 and is utilized as the synapses and parts of neurons between an input layer and the next layer. VMM array 900 comprises memory array 901 of non-volatile memory cells and reference array 902 (at the top of the array) of non-volatile reference memory cells. Alternatively, another reference array can be placed at the bottom.

In VMM array 900, control gate lines, such as control gate line 903, run in a vertical direction (hence reference array 902 in the row direction is orthogonal to control gate line 903), and erase gate lines, such as erase gate line 904, run in a horizontal direction. Here, the inputs to VMM array 900 are provided on the control gate lines (CG0, CG1, CG2, CG3), and the output of VMM array 900 emerges on the source lines (SL0, SL1). In one example, only even rows are used, and in another example, only odd rows are used. The current placed on each source line (SL0, SL1, respectively) performs a summing function of all the currents from the memory cells connected to that particular source line.

As described herein for neural networks, the non-volatile memory cells of VMM array 900, i.e., the memory cells 310 VMM array 900, may be configured to operate in a sub-threshold region.

The non-volatile reference memory cells and the non-volatile memory cells described herein are biased in weak inversion (sub threshold region):

Ids=Io*e^{(Vg-Vth)/nVt}=w*Io*e^{(Vg)/nVt},

where w=e^{(-Vth)/nVt}
where Ids is the drain to source current; Vg is gate voltage on the memory cell; Vth is threshold voltage of the memory cell; Vt is thermal voltage=k*T/q with k being the Boltzmann constant, T the temperature in Kelvin, and q the electronic charge; n is a slope factor=1+(Cdep/Cox) with Cdep=capacitance of the depletion layer, and Cox capacitance of the gate oxide layer; Io is the memory cell current at gate voltage equal to threshold voltage, Io is proportional to (Wt/L)*u*Cox*(n−1)* Vt² where u is carrier mobility and Wt and L are width and length, respectively, of the memory cell.

For an I-to-V log converter using a memory cell (such as a reference memory cell or a peripheral memory cell) or a transistor to convert input current into an input voltage:

Vg=n*Vt*log [Ids/wp*Io]

where, wp is w of a reference or peripheral memory cell.

For a memory array used as a vector matrix multiplier VMM array with the current input, the output current is:

Iout=wa*Io*e^{(Vg)/nVt}, namely

Iout=(wa/wp)*Iin=W*Iin

W=e^{(Vthp-Vtha)/nVt}

Here, wa=w of each memory cell in the memory array. Vthp is effective threshold voltage of the peripheral memory cell and Vtha is effective threshold voltage of the main (data) memory cell. Note that the threshold voltage of a transistor is a function of substrate body bias voltage and the substrate body bias voltage, denoted Vsb, can be modulated to compensate for various conditions, on such temperature. The threshold voltage Vth can be expressed as:

Vth=Vth0+gamma (SQRT|Vsb−2*φF)−SQRT|2*φF |)

where Vth0 is threshold voltage with zero substrate bias, φF is a surface potential, and gamma is a body effect parameter.

A wordline or control gate can be used as the input for the memory cell for the input voltage.

Alternatively, the flash memory cells of VMM arrays described herein can be configured to operate in the linear region:

Ids=beta*(Vgs−Vth)*Vds ; beta=u*Cox*Wt/L

W=α(Vgs−Vth)

meaning weight W in the linear region is proportional to (Vgs−Vth)

A wordline or control gate or bitline or sourceline can be used as the input for the memory cell operated in the linear region. The bitline or sourceline can be used as the output for the memory cell.

For an I-to-V linear converter, a memory cell (such as a reference memory cell or a peripheral memory cell) or a transistor operating in the linear region can be used to linearly convert an input/output current into an input/output voltage.

Alternatively, the memory cells of VMM arrays described herein can be configured to operate in the saturation region:

Ids=½*beta*(Vgs−Vth)²; beta=u*Cox*Wt/L

Wα (Vgs−Vth)²,

meaning weight W is proportional to (Vgs−Vth)²

A wordline, control gate, or erase gate can be used as the input for the memory cell operated in the saturation region. The bitline or sourceline can be used as the output for the output neuron.

Alternatively, the memory cells of VMM arrays described herein can be used in all regions or a combination thereof (sub threshold, linear, or saturation) for each layer or multi layers of a neural network.

Other examples for VMM array 32 of FIG. 7 are described in U.S. Pat. No. 10,748,630, which is incorporated by reference herein. As described in that application. a sourceline or a bitline can be used as the neuron output (current summation output).

FIG. 10 depicts neuron VMM array 1000, which is particularly suited for memory cells 210 as shown in FIG. 2 and is utilized as the synapses between an input layer and the next layer. VMM array 1000 comprises a memory array 1003 of non-volatile memory cells, reference array 1001 of first non-volatile reference memory cells, and reference array 1002 of second non-volatile reference memory cells. Reference arrays 1001 and 1002, arranged in the column direction of the array, serve to convert current inputs flowing into terminals BLR0, BLR1, BLR2, and BLR3 into voltage inputs WL0, WL1, WL2, and WL3. In effect, the first and second non-volatile reference memory cells are diode-connected through multiplexors 1014 (only partially depicted) with current inputs flowing into them. The reference cells are tuned (e.g., programmed) to target reference levels. The target reference levels are provided by a reference mini-array matrix (not shown).

Memory array 1003 serves two purposes. First, it stores the weights that will be used by the VMM array 1000 on respective memory cells thereof. Second, memory array 1003 effectively multiplies the inputs (i.e. current inputs provided in terminals BLR0, BLR1, BLR2, and BLR3, which reference arrays 1001 and 1002 convert into the input voltages to supply to wordlines WL0, WL1, WL2, and WL3) by the weights stored in the memory array 1003 and then adds all the results (memory cell currents) to produce the output on the respective bit lines (BL0-BLN), which will be the input to the next layer or input to the final layer. By performing the multiplication and addition function, memory array 1003 negates the need for separate multiplication and addition logic circuits and is also power efficient. Here, the voltage inputs are provided on the word lines WL0, WL1, WL2, and WL3, and the output emerges on the respective bit lines BL0-BLN during a read (inference) operation. The current placed on each of the bit lines BL0-BLN performs a summing function of the currents from all non-volatile memory cells connected to that particular bitline.

Table No. 5 depicts operating voltages and currents for VMM array 1000. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO. 5
Operation of VMM Array 1000 of FIG. 10:

| | | | | | |
|---|---|---|---|---|---|
| WL | WL -unsel | BL | BL -unsel | SL | SL -unsel |

| Read | 1-3.5 | V | −0.5 V/0 V | 0.6-2 V | | 0.6 V-2 V/0 V | 0 V | 0 | V |
|---|---|---|---|---|---|---|---|---|---|
| | | | | (Ineuron) | | | | | |
| Erase | ~5-13 | V | 0 V | 0 | V | 0 V | 0 V | 0 | V |
| Program | 1-2 | V | −0.5 V/0 V | 0.1-3 | uA | Vinh ~2.5 V | 4-10 V | 0-1 | V/FLT |

FIG. 11 depicts neuron VMM array 1100, which is particularly suited for memory cells 210 as shown in FIG. 2 and is utilized as the synapses and parts of neurons between an input layer and the next layer. VMM array 1100 comprises a memory array 1103 of non-volatile memory cells, reference array 1101 of first non-volatile reference memory cells, and reference array 1102 of second non-volatile reference memory cells. Reference arrays 1101 and 1102 run in row direction of the VMM array 1100. VMM array is similar to VMM 1000 except that in VMM array 1100, the word lines run in the vertical direction. Here, the inputs are provided on the word lines (WLA0, WLB0, WLA1, WLB2, WLA2, WLB2, WLA3, WLB3), and the output emerges on the source line (SL0, SL1) during a read operation. The current placed on each source line performs a summing function of all the currents from the memory cells connected to that particular source line.

Table No. 6 depicts operating voltages and currents for VMM array 1100. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO. 6
Operation of VMM Array 1100 of FIG. 11

| | | | | | |
|---|---|---|---|---|---|
| WL | WL -unsel | BL | BL -unsel | SL | SL -unsel |

| Read | 1-3.5 | V | −0.5 V/0 V | 0.6-2 | V | 0.6 V-2 V/0 V | ~0.3-1 V | | 0 | V |
|---|---|---|---|---|---|---|---|---|---|---|
| | | | | | | | (Ineuron) | | | |
| Erase | ~5-13 | V | 0 V | 0 | V | 0 V | 0 | V | SL-inhibit | |
| | | | | | | | | | (~4-8 V) | |
| Program | 1-2 | V | −0.5 V/0 V | 0.1-3 | uA | Vinh ~2.5 V | 4-10 | V | 0-1 | V/FLT |

FIG. 12 depicts neuron VMM array 1200, which is particularly suited for memory cells 310 as shown in FIG. 3 and is utilized as the synapses and parts of neurons between an input layer and the next layer. VMM array 1200 comprises a memory array 1203 of non-volatile memory cells, reference array 1201 of first non-volatile reference memory cells, and reference array 1202 of second non-volatile reference memory cells. Reference arrays 1201 and 1202 serve to convert current inputs flowing into terminals BLR0, BLR1, BLR2, and BLR3 into voltage inputs CG0, CG1, CG2, and CG3. In effect, the first and second non-volatile reference memory cells are diode-connected through multiplexors 1212 (only partially shown) with current inputs flowing into them through BLR0, BLR1, BLR2, and BLR3. Multiplexors 1212 each include a respective multiplexor 1205 and a cascoding transistor 1204 to ensure a constant voltage on the bitline (such as BLR0) of each of the first and second non-volatile reference memory cells during a read operation. The reference cells are tuned to target reference levels.

Memory array 1203 serves two purposes. First, it stores the weights that will be used by the VMM array 1200. Second, memory array 1203 effectively multiplies the inputs (current inputs provided to terminals BLR0, BLR1, BLR2, and BLR3, for which reference arrays 1201 and 1202 convert these current inputs into the input voltages to supply to the control gates (CG0, CG1, CG2, and CG3) by the weights stored in the memory array and then add all the results (cell currents) to produce the output, which appears on BL0-BLN, and will be the input to the next layer or input to the final layer. By performing the multiplication and addition function, the memory array negates the need for separate multiplication and addition logic circuits and is also power efficient. Here, the inputs are provided on the control gate lines (CG0, CG1, CG2, and CG3), and the output emerges on the bit lines (BL0-BLN) during a read operation. The current placed on each bitline performs a summing function of all the currents from the memory cells connected to that particular bitline.

VMM array 1200 implements uni-directional tuning for non-volatile memory cells in memory array 1203. That is, each non-volatile memory cell is erased and then partially programmed until the desired charge on the floating gate is reached. If too much charge is placed on the floating gate (such that the wrong value is stored in the cell), the cell is erased and the sequence of partial programming operations starts over. As shown, two rows sharing the same erase gate (such as EG0 or EG1) are erased together (which is known as a page erase), and thereafter, each cell is partially programmed until the desired charge on the floating gate is reached.

Table No. 7 depicts operating voltages and currents for VMM array 1200. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO. 7
Operation of VMM Array 1200 of FIG. 12

| | | | | | | | | | CG - | | | | | | |
|---|---|---|---|---|---|---|---|---|---|---|---|---|---|---|---|
| | | | WL - | | | BL - | | | unsel same | CG - | | EG - | | | SL - |
| | WL | | unsel | BL | | unsel | CG | | sector | unsel | EG | unsel | SL | | unsel |
| Read | 1.0-2 | V | −0.5 V/ 0 V | 0.6-2 V | | 0 V | 0-2.6 | V | 0-2.6 V | 0-2.6 V | 0-2.6 V | 0-2.6 V | 0 | V | 0 V |
| | | | | (Ineuron) | | | | | | | | | | | |
| Erase | 0 | V | 0 V | 0 | V | 0 V | 0 | V | 0-2.6 V | 0-2.6 V | 5-12 V | 0-2.6 V | 0 | V | 0 V |
| Program | 0.7-1 | V | −0.5 V/0 V | 0.1-1 | uA | Vinh | 4-11 | V | 0-2.6 V | 0-2.6 V | 4.5-5 V | 0-2.6 V | 4.5-5 | V | 0-1 V |
| | | | | | | (1-2 V) | | | | | | | | | |

FIG. 13 depicts neuron VMM array 1300, which is particularly suited for memory cells 310 as shown in FIG. 3, and is utilized as the synapses and parts of neurons between an input layer and the next layer. VMM array 1300 comprises a memory array 1303 of non-volatile memory cells, reference array 1301 or first non-volatile reference memory cells, and reference array 1302 of second non-volatile reference memory cells. EG lines EGR0, EG0, EG1 and EGR1 are run vertically while CG lines CG0, CG1, CG2 and CG3 and SL lines WL0, WL1, WL2 and WL3 are run horizontally. VMM array 1300 is similar to VMM array 1400, except that VMM array 1300 implements bi-directional tuning, where each individual cell can be completely erased, partially programmed, and partially erased as needed to reach the desired amount of charge on the floating gate due to the use of separate EG lines. As shown, reference arrays 1301 and 1302 convert input current in the terminal BLR0, BLR1, BLR2, and BLR3 into control gate voltages CG0, CG1, CG2 and CG3 (through the action of diode-connected reference cells through multiplexors 1314) to be applied to the memory cells in the row direction. The current output (neuron) is in the bit lines BL0-BLN, where each bit line sums all currents from the non-volatile memory cells connected to that particular bitline.

Table No. 8 depicts operating voltages and currents for VMM array 1300. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO. 8
Operation of VMM Array 1300 of FIG. 13

| | | | | | | | | | CG - | | | | | | |
|---|---|---|---|---|---|---|---|---|---|---|---|---|---|---|---|
| | | | WL - | | | BL - | | | unsel same | CG - | | EG - | | | SL - |
| | WL | | unsel | BL | | unsel | CG | | sector | unsel | EG | unsel | SL | | unsel |
| Read | 1.0-2 | V | −0.5 V/0 V | 0.6-2 V | | 0 V | 0-2.6 | V | 0-2.6 V | 0-2.6 V | 0-2.6 V | 0-2.6 V | 0 | V | 0 V |
| | | | | (Ineuron) | | | | | | | | | | | |
| Erase | 0 | V | 0 V | 0 | V | 0 V | 0 | V | 4-9 V | 0-2.6 V | 5-12 V | 0-2.6 V | 0 | V | 0 V |
| Program | 0.7-1 | V | −0.5 V/0 V | 0.1-1 | uA | Vinh | 4-11 | V | 0-2.6 V | 0-2.6 V | 4.5-5 V | 0-2.6 V | 4.5-5 | V | 0-1 V |
| | | | | | | (1-2 V) | | | | | | | | | |

FIG. 22 depicts neuron VMM array 2200, which is particularly suited for memory cells 210 as shown in FIG. 2 and is utilized as the synapses and parts of neurons between an input layer and the next layer. In VMM array 2200, the inputs INPUT₀. . . . , INPUT_{N} are received on bit lines BL₀, . . . BL_{N}, respectively, and the outputs OUTPUT₁, OUTPUT₂, OUTPUT₃, and OUTPUT₄ are generated on source lines SL₀, SL₁, SL₂, and SL₃, respectively.

FIG. 23 depicts neuron VMM array 2300, which is particularly suited for memory cells 210 as shown in FIG. 2 and is utilized as the synapses and parts of neurons between an input layer and the next layer. In this example, the inputs INPUT₀, INPUT₁, INPUT₂, and INPUT₃ are received on source lines SL₀, SL₁, SL₂, and SL₃, respectively, and the outputs OUTPUT₀, . . . OUTPUT_{N} are generated on bit lines BLo, BLN.

FIG. 24 depicts neuron VMM array 2400, which is particularly suited for memory cells 210 as shown in FIG. 2, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . OUTPUT_{N} are generated on bit lines BL₀, . . . , BL_{N}.

FIG. 25 depicts neuron VMM array 2500, which is particularly suited for memory cells 310 as shown in FIG. 3, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . OUTPUT_{N} are generated on bit lines BL₀, . . . , BL_{N}.

FIG. 26 depicts neuron VMM array 2600, which is particularly suited for memory cells 410 as shown in FIG. 4, and is utilized as the synapses and parts of neurons between an input layer and the next layer. In this example, the inputs INPUT₀, . . . , INPUTₙ are received on vertical control gate lines CG₀, . . . , CG_{N}, respectively, and the outputs OUTPUT₁ and OUTPUT₂ are generated on source lines SL₀ and SL₁.

FIG. 27 depicts neuron VMM array 2700, which is particularly suited for memory cells 410 as shown in FIG. 4 and is utilized as the synapses and parts of neurons between an input layer and the next layer. In this example, the inputs INPUT₀, . . . , INPUT_{N} are received on the gates of bit line control gates 2701-1, 2701-2, . . . , 2701-(N-1), and 2701-N, respectively, which are coupled to bit lines BL₀, . . . , BL_{N}, respectively. Example outputs OUTPUT₁ and OUTPUT₂ are generated on source lines SL₀ and SL₁.

FIG. 28 depicts neuron VMM array 2800, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on word lines WL₀, . . . , WL_{M}, and the outputs OUTPUT₀, . . . , OUTPUT_{N} are generated on bit lines BL₀, . . . , BL_{N}, respectively.

FIG. 29 depicts neuron VMM array 2900, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical source lines SL₀, . . . , SL_{N}, respectively, where each source line SLᵢ is coupled to the source lines of all memory cells in column i.

FIG. 30 depicts neuron VMM array 3000, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical bit lines BL₀, . . . , BL_{N}, respectively, where each bit line BLᵢ is coupled to the bit lines of all memory cells in column i.

### Long Short-Term Memory

The prior art includes a concept known as long short-term memory (LSTM). LSTM units often are used in neural networks. LSTM allows a neural network to remember information over predetermined arbitrary time intervals and to use that information in subsequent operations. A conventional LSTM unit comprises a cell, an input gate, an output gate, and a forget gate. The three gates regulate the flow of information into and out of the cell and the time interval that the information is remembered in the LSTM. VMMs are particularly useful in LSTM units.

FIG. 14 depicts an example LSTM 1400. LSTM 1400 in this example comprises cells 1401, 1402, 1403, and 1404. Cell 1401 receives input vector x₀ and generates output vector h₀ and cell state vector c₀. Cell 1402 receives input vector x₁, the output vector (hidden state) h₀ from cell 1401, and cell state c₀ from cell 1401 and generates output vector h₁ and cell state vector c₁. Cell 1403 receives input vector x₂, the output vector (hidden state) h₁ from cell 1402, and cell state c₁ from cell 1402 and generates output vector h₂ and cell state vector c₂. Cell 1404 receives input vector x₃, the output vector (hidden state) h₂ from cell 1403, and cell state c₂ from cell 1403 and generates output vector h₃. Additional cells can be used, and an LSTM with four cells is merely an example.

FIG. 15 depicts an example implementation of an LSTM cell 1500. which can be used for cells 1401. 1402, 1403, and 1404 in FIG. 14, LSTM cell 1500 receives input vector x(t), cell state vector c(t−1) from a preceding cell, and output vector h(t−1) from a preceding cell, and generates cell state vector c(t) and output vector h(t).

LSTM cell 1500 comprises sigmoid function devices 1501, 1502, and 1503, each of which applies a number between 0 and 1 to control how much of each component in the input vector is allowed through to the output vector. LSTM cell 1500 also comprises tanh devices 1504 and 1505 to apply a hyperbolic tangent function to an input vector, multiplier devices 1506, 1507, and 1508 to multiply two vectors together, and addition device 1509 to add two vectors together. Output vector h(t) can be provided to the next LSTM cell in the system, or it can be accessed for other purposes.

FIG. 16 depicts an LSTM cell 1600, which is an example of an implementation of LSTM cell 1500. For the reader's convenience, the same numbering from LSTM cell 1500 is used in LSTM cell 1600. Sigmoid function devices 1501, 1502, and 1503 and tanh device 1504 each comprise multiple VMM arrays 1601 and activation function blocks 1602. Thus, it can be seen that VMM arrays are particular useful in LSTM cells used in certain neural network systems. The multiplier devices 1506, 1507, and 1508 and the addition device 1509 are implemented in a digital manner or in an analog manner. The activation function blocks 1602 can be implemented in a digital manner or in an analog manner.

An alternative to LSTM cell 1600 (and another example of an implementation of LSTM cell 1500) is shown in FIG. 17. In FIG. 17, sigmoid function devices 1501, 1502, and 1503 and tanh device 1504 share the same physical hardware (VMM arrays 1701 and activation function block 1702) in a time-multiplexed fashion. LSTM cell 1700 also comprises multiplier device 1703 to multiply two vectors together, addition device 1708 to add two vectors together, tanh device 1505 (which comprises activation function block 1702), register 1707 to store the value i(t) when i(t) is output from sigmoid function block 1702, register 1704 to store the value f(t)*c(t−1) when that value is output from multiplier device 1703 through multiplexor 1710, register 1705 to store the value i(t) u(t) when that value is output from multiplier device 1703 through multiplexor 1710, and register 1706 to store the value o(t)*c˜(t) when that value is output from multiplier device 1703 through multiplexor 1710, and multiplexor 1709.

Whereas LSTM cell 1600 contains multiple sets of VMM arrays 1601 and respective activation function blocks 1602, LSTM cell 1700 contains only one set of VMM arrays 1701 and activation function block 1702, which are used to represent multiple layers in the example of LSTM cell 1700. LSTM cell 1700 will require less space than LSTM 1600, as LSTM cell 1700 will require ¼ as much space for VMMs and activation function blocks compared to LSTM cell 1600.

It can be further appreciated that LSTM units will typically comprise multiple VMM arrays, each of which requires functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry required outside of the VMM arrays themselves.

### Gated Recurrent Units

An analog VMM implementation can be utilized for a GRU (gated recurrent unit) system. GRUs are a gating mechanism in recurrent neural networks. GRUs are similar to LSTMs, except that GRU cells generally contain fewer components than an LSTM cell.

FIG. 18 depicts an example GRU 1800. GRU 1800 in this example comprises cells 1801, 1802, 1803, and 1804. Cell 1801 receives input vector x₀ and generates output vector h₀. Cell 1802 receives input vector x₁, the output vector h₀ from cell 1801 and generates output vector h₁. Cell 1803 receives input vector x₂ and the output vector (hidden state) h₁ from cell 1802 and generates output vector h₂. Cell 1804 receives input vector x₃ and the output vector (hidden state) h₂ from cell 1803 and generates output vector h₃. Additional cells can be used, and an GRU with four cells is merely an example.

FIG. 19 depicts an example implementation of a GRU cell 1900, which can be used for cells 1801, 1802, 1803, and 1804 of FIG. 18. GRU cell 1900 receives input vector x(t) and output vector h(t−1) from a preceding GRU cell and generates output vector h(t), GRU cell 1900 comprises sigmoid function devices 1901 and 1902, each of which applies a number between 0 and 1 to components from output vector h(t−1) and input vector x(t). GRU cell 1900 also comprises a tanh device 1903 to apply a hyperbolic tangent function to an input vector, a plurality of multiplier devices 1904, 1905, and 1906 to multiply two vectors together, an addition device 1907 to add two vectors together, and a complementary device 1908 to subtract an input from 1 to generate an output.

FIG. 20 depicts a GRU cell 2000, which is an example of an implementation of GRU cell 1900. For the reader's convenience, the same numbering from GRU cell 1900 is used in GRU cell 2000. As can be seen in FIG. 20. sigmoid function devices 1901 and 1902, and tanh device 1903 each comprise multiple VMM arrays 2001 and activation function blocks 2002. Thus, it can be seen that VMM arrays are of particular use in GRU cells used in certain neural network systems. The multiplier devices 1904, 1905, 1906, the addition device 1907, and the complementary device 1908 are implemented in a digital manner or in an analog manner. The activation function blocks 2002 can be implemented in a digital manner or in an analog manner.

An alternative to GRU cell 2000 (and another example of an implementation of GRU cell 1900) is shown in FIG. 21. In FIG. 21, GRU cell 2100 utilizes VMM arrays 2101 and activation function block 2102, which when configured as a sigmoid function applies a number between 0 and 1 to control how much of each component in the input vector is allowed through to the output vector. In FIG. 21, sigmoid function devices 1901 and 1902 and tank device 1903 share the same physical hardware (VMM arrays 2101 and activation function block 2102) in a time-multiplexed fashion. GRU cell 2100 also comprises multiplier device 2103 to multiply two vectors together, addition device 2105 to add two vectors together, complementary device 2109 to subtract an input from 1 to generate an output, multiplexor 2104, register 2106 to hold the value h(t−1)*r(t) when that value is output from multiplier device 2103 through multiplexor 2104, register 2107 to hold the value h(t−1)*z(t) when that value is output from multiplier device 2103 through multiplexor 2104, and register 2108 to hold the value h\hat{ }(t)*(1−z(t)) when that value is output from multiplier device 2103 through multiplexor 2104.

Whereas GRU cell 2000 contains multiple sets of VMM arrays 2001 and activation function blocks 2002, GRU cell 2100 contains only one set of VMM arrays 2101 and activation function block 2102, which are used to represent multiple layers in the example of GRU cell 2100. GRU cell 2100 will require less space than GRU cell 2000, as GRU cell 2100 will require ⅓ as much space for VMMs and activation function blocks compared to GRU cell 2000.

It can be further appreciated that GRU systems -will typically comprise multiple VMM arrays, each of which requires functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry required outside of the VMM arrays themselves.

The input to the VMM arrays can be an analog level, a binary level, a pulse, a time modulated pulse, or digital bits (in this case a DAC is needed to convert digital bits to appropriate input analog level) and the output can be an analog level, a binary level, a timing pulse, pulses, or digital bits (in this case an output ADC is needed to convert output analog level into digital bits).

In general, for each memory cell in a VMM array, each weight W can be implemented by a single memory cell or by a differential cell or by two blend memory cells (average of 2 cells). In the differential cell case, two memory cells are needed to implement a weight W as a differential weight (W=W+−W−). In the two blend memory cells, two memory cells are needed to implement a weight W as an average of two cells.

FIG. 31 depicts VMM system 3100. In some examples, the weights, W, stored in a VMM array are stored as differential pairs, W+ (positive weight) and W− (negative weight), where W=(W+)−(W−). In VMM system 3100, half of the bit lines are designated as W+ lines, that is, bit lines connecting to memory cells that will store positive weights W+, and the other half of the bit lines are designated as W− lines, that is, bit lines connecting to memory cells implementing negative weights W−. The W− lines are interspersed among the W+ lines in an alternating fashion. The subtraction operation is performed by a summation circuit that receives current from a W+ line and a W− line, such as summation circuits 3101 and 3102. The output of a W+ line and the output of a W− line are combined together to give effectively W=W+−W− for each pair of (W+, W−) cells for all pairs of (W+, W−) lines. While the above has been described in relation to W− lines interspersed among the W+ lines in an alternating fashion, in other examples W+ lines and W− lines can be arbitrarily located anywhere in the array.

FIG. 32 depicts another example. In VMM system 3210, positive weights W+ are implemented in first array 3211 and negative weights W− are implemented in a second array 3212, second array 3212 separate from the first array, and the resulting weights are appropriately combined together by summation circuits 3213.

FIG. 33 depicts VMM system 3300. the weights, W, stored in a VMM array are stored as differential pairs, W+ (positive weight) and W− (negative weight), where W=(W+)−(W−). VMM system 3300 comprises array 3301 and array 3302. Half of the bit lines in each of array 3301 and 3302 are designated as W+ lines, that is, bit lines connecting to memory cells that will store positive weights W+, and the other half of the bit lines in each of array 3301 and 3302 are designated as W− lines, that is, bit lines connecting to memory cells implementing negative weights W−. The W− lines are interspersed among the W+lines in an alternating fashion. The subtraction operation is performed by a summation circuit that receives current from a W+ line and a W− line, such as summation circuits 3303, 3304, 3305, and 3306. The output of a W+ line and the output of a W− line from each array 3301, 3302 are respectively combined together to give effectively W=W+−W− for each pair of (W+, W−) cells for all pairs of (W+, W−) lines. In addition, the W values from each array 3301 and 3302 can be further combined through summation circuits 3307 and 3308, such that each W value is the result of a W value from array 3301 minus a W value from array 3302, meaning that the end result from summation circuits 3307 and 3308 is a differential value of two differential values.

Each non-volatile memory cells used in the analog neural memory system is to be erased and programmed to hold a very specific and precise amount of charge, i.e., the number of electrons, in the floating gate. For example, each floating gate should hold one of N different values, where N is the number of different weights that can be indicated by each cell. Examples of N include 16, 32, 64, 128, and 256.

FIG. 34 depicts a block diagram of a VMM system 3400. VMM system 3400 comprises VMM array 3401, row decoder 3402, high voltage decoder 3403, column decoders 3404, bit line drivers 3405, input circuit 3406, output circuit 3407, control logic 3408, and bias generator 3409. VMM system 3400 further comprises high voltage generation block 3410, which comprises charge pump 3411, charge pump regulator 3412, and high voltage analog precision level generator 3413. VMM system 3400 further comprises (program/erase, or weight tuning) algorithm controller 3414, analog circuitry 3415, control engine 3416 (that may include special functions such as arithmetic functions, activation functions, embedded microcontroller logic, without limitation), and test control logic 3417.

The input circuit 3406 may include circuits such as a DAC (digital to analog converter), DPC (digital to pulses converter, digital to time modulated pulse converter), AAC (analog to analog converter, such as a current to voltage converter, logarithmic converter), PAC (pulse to analog level converter), or any other type of converters. The input circuit 3406 may implement one or more of normalization, linear or non-linear up/down scaling functions, or arithmetic functions. The input circuit 3406 may implement a temperature compensation function for input levels. The input circuit 3406 may implement an activation function such as ReLU or sigmoid.

The output circuit 3407 may include circuits such as an ADC (analog to digital converter, to convert neuron analog output to digital bits), AAC (analog to analog converter, such as a current to voltage converter, logarithmic converter), APC (analog to pulse(s) converter, analog to time modulated pulse converter), or any other type of converters. The output circuit 3407 may implement an activation function such as rectified linear activation function (ReLU) or sigmoid. The output circuit 3407 may implement one or more of statistic normalization, regularization, up/down scaling/gain functions, statistical rounding, or arithmetic functions (e.g., add, subtract, divide, multiply, shift, log) for neuron outputs. The output circuit 3407 may implement a temperature compensation function for neuron outputs or array outputs (such as bitline output) so as to keep power consumption of the array approximately constant or to improve precision of the array (neuron) outputs such as by keeping the IV slope approximately the same.

As the applications for artificial neural networks become more complex, there is an increasing need for larger VMM arrays. At the same time, there exists a need to efficiently use space within a packaged integrated circuit and to save power as much as possible while still maintaining accuracy so that each of the N different weights are still stored and read properly.

### SUMMARY OF THE INVENTION

Numerous examples are described for providing an artificial neural network system comprising a three-dimensional integrated circuit comprising one or more VMM arrays.

### BRIEF DESCRIPTION OF THE DRAWINGS

FIG. 1 is a diagram that illustrates an artificial neural network.

FIG. 2 depicts a prior art split gate flash memory cell.

FIG. 3 depicts another prior art split gate flash memory cell.

FIG. 4 depicts another prior art split gate flash memory cell.

FIG. 5 depicts another prior art split gate flash memory cell.

FIG. 6 is a diagram illustrating the different levels of an example artificial neural network utilizing one or more non-volatile memory arrays.

FIG. 7 is a block diagram illustrating a VMM system.

FIG. 8 is a block diagram illustrates an example artificial neural network utilizing one or more VMM systems.

FIG. 9 depicts another example of a VMM system.

FIG. 10 depicts another example of a VMM system.

FIG. 11 depicts another example of a VMM system.

FIG. 12 depicts another example of a VMM system.

FIG. 13 depicts another example t of a VMM system.

FIG. 14 depicts a prior art long short-term memory system.

FIG. 15 depicts an example cell for use in a long short-term memory system.

FIG. 16 depicts an example implementation of the cell of FIG. 15.

FIG. 17 depicts another example implementation of the cell of FIG. 15.

FIG. 18 depicts a prior art gated recurrent unit system.

FIG. 19 depicts an example cell for use in a gated recurrent unit system.

FIG. 20 depicts an example implementation t of the cell of FIG. 19.

FIG. 21 depicts another example implementation of the cell of FIG. 19.

FIG. 22 depicts another example of a VMM system.

FIG. 23 depicts another example of a VMM system.

FIG. 24 depicts another example of a VMM system.

FIG. 25 depicts another example of a VMM system.

FIG. 26 depicts another example of a VMM system.

FIG. 27 depicts another example of a VMM system.

FIG. 28 depicts another example of a VMM system.

FIG. 29 depicts another example of a VMM system.

FIG. 30 depicts another example of a VMM system.

FIG. 31 depicts another example of a VMM system.

FIG. 32 depicts another example of a VMM system.

FIG. 33 depicts another example of a VMM system.

FIG. 34 depicts an example of a 2D VMM system.

FIG. 35 depicts an example of a 3D VMM system.

FIG. 36 depicts an example of a 3D VMM system.

FIGS. 37A and 37B depict examples of a 3D VMM system.

FIG. 38 depicts an example of a 3D VMM system.

FIGS. 39A, 39B, and 39C depict examples of a 3D VMM system.

FIG. 40 depicts an example of a 3D VMM system.

FIG. 41 depicts an example of a 3D VMM system.

FIG. 42 depicts an example of a 3D VMM system.

FIG. 43 depicts an example of a 3D VMM system.

FIG. 44 depicts an example of a 3D VMM system.

FIG. 45 depicts an example of a 3D VMM system.

FIG. 46 depicts an example of a 3D VMM system.

FIG. 47 depicts an example of a 3D VMM system.

FIG. 48 depicts an example of a 3D VMM system.

FIG. 49 depicts an example of a neuron circuit.

FIG. 50 depicts an example of a neuron circuit.

FIG. 51 depicts an example of a drive circuit.

FIG. 52 depicts an example of a differential neuron circuit.

FIG. 53 depicts an example of a sample-and-hold buffer.

FIG. 54 depicts an example of an ADC circuit.

FIG. 55 depicts an example of an ADC circuit.

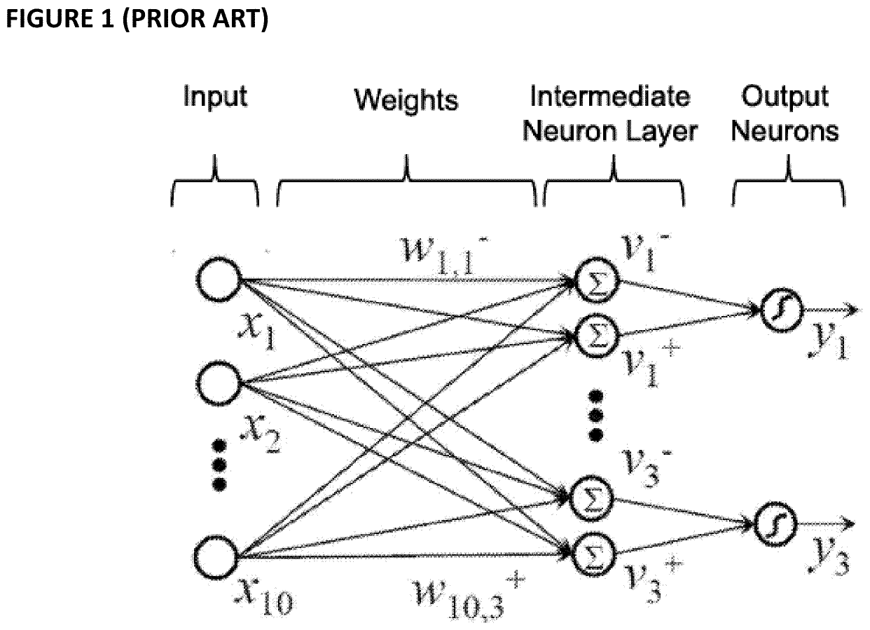

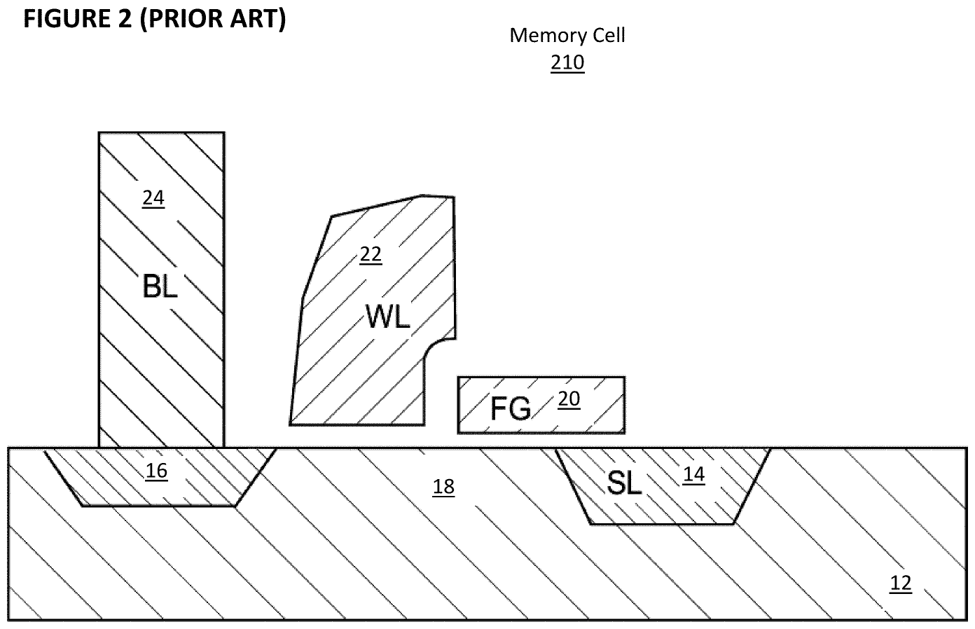

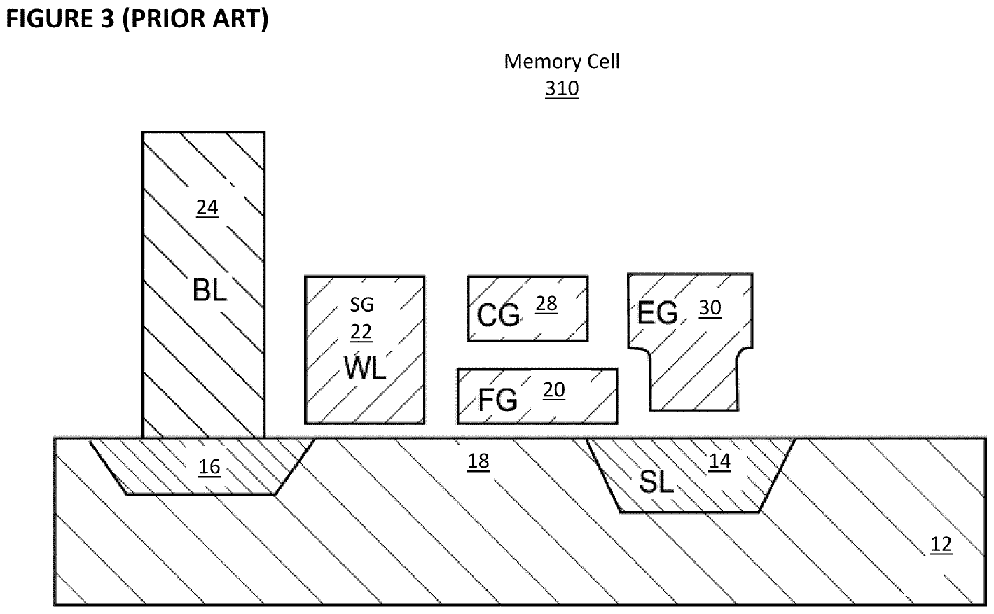

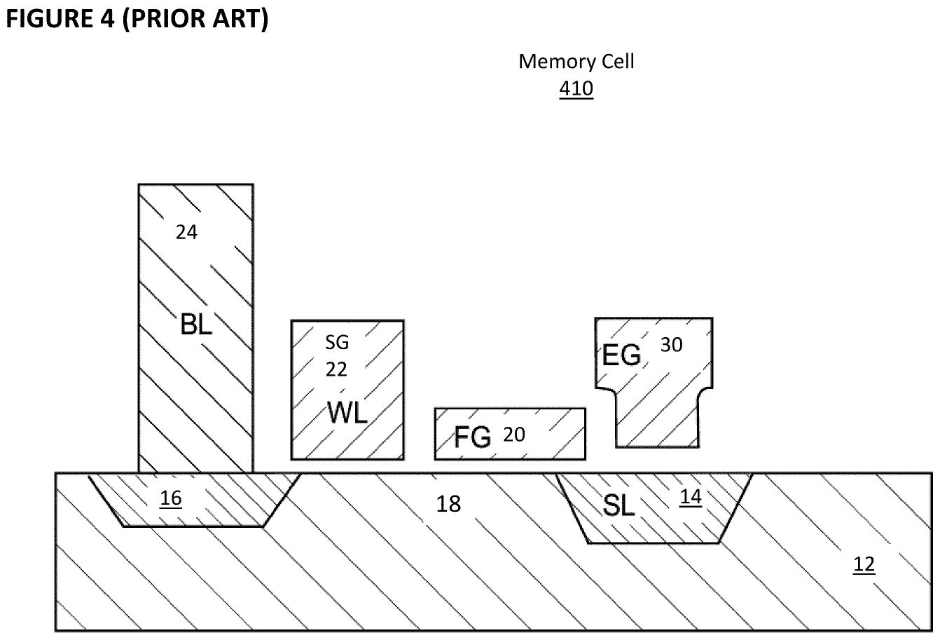

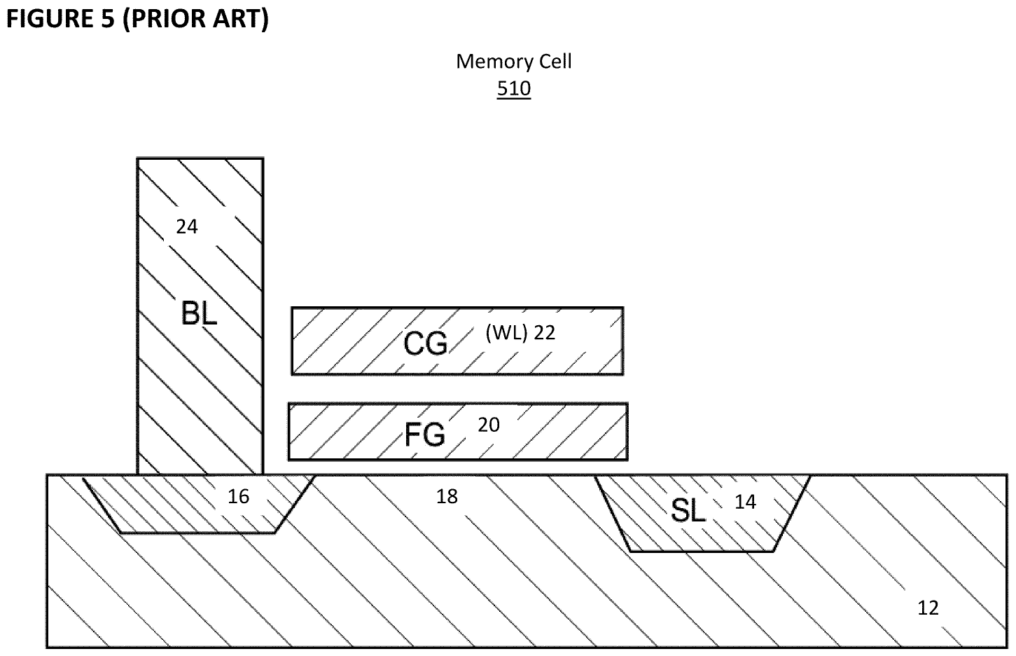

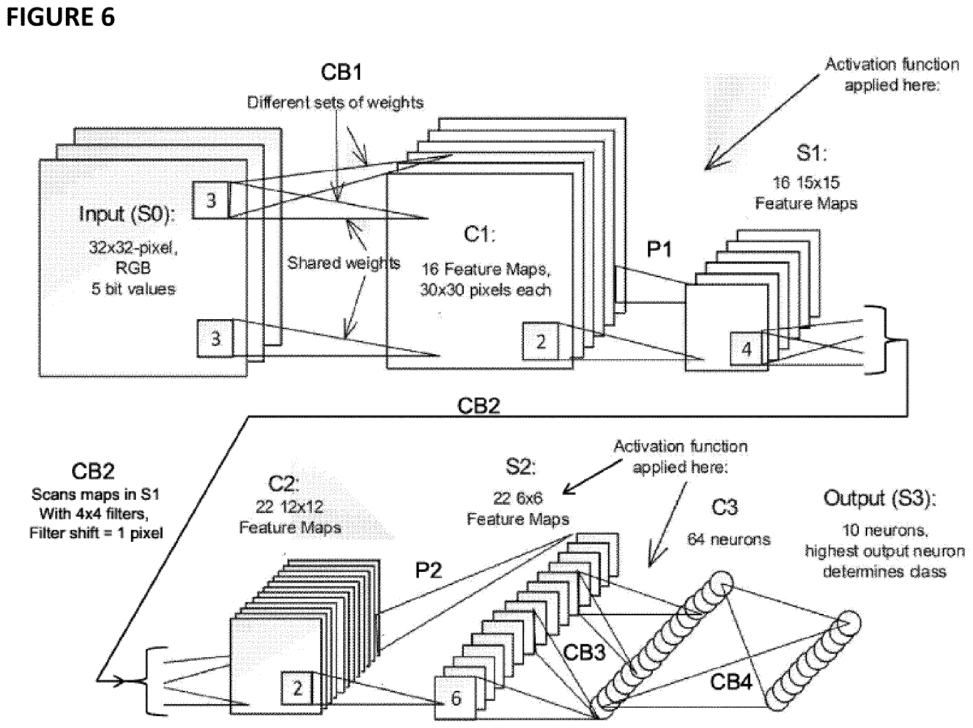

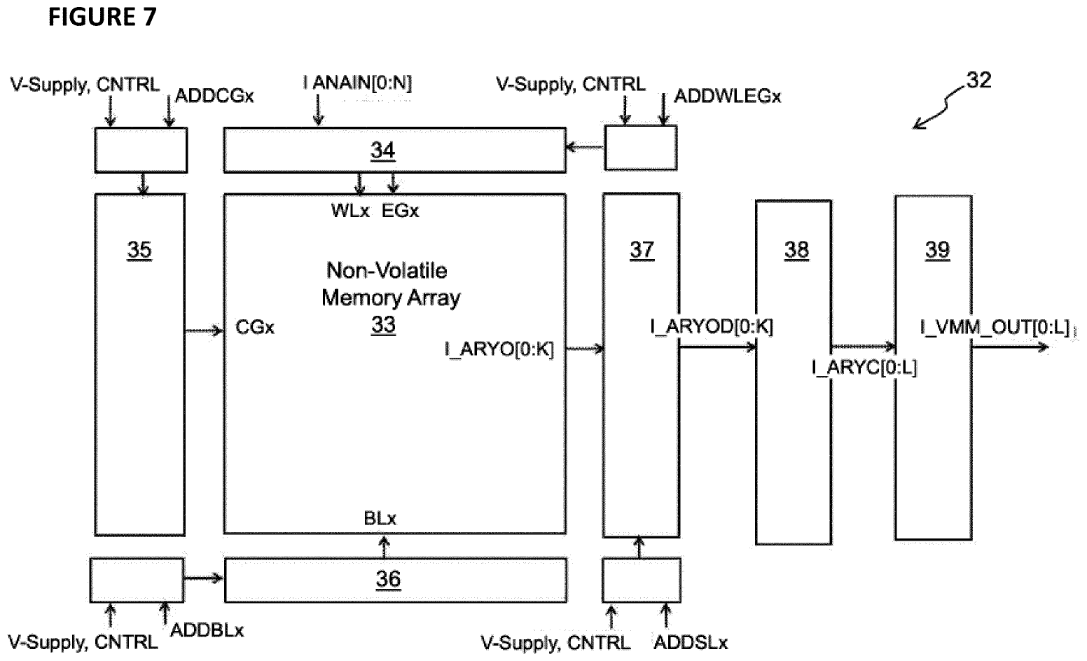

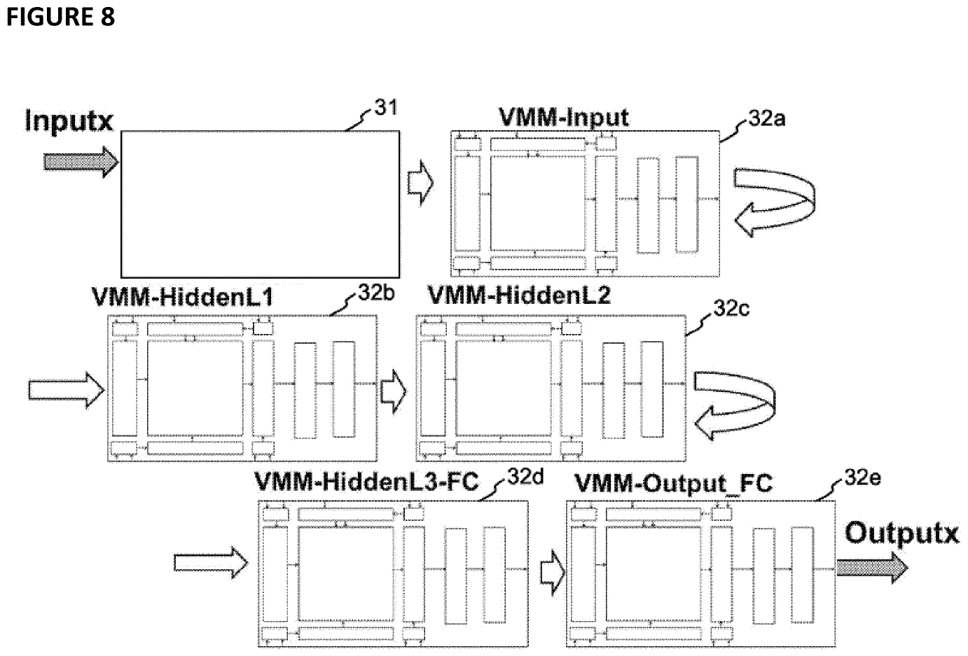

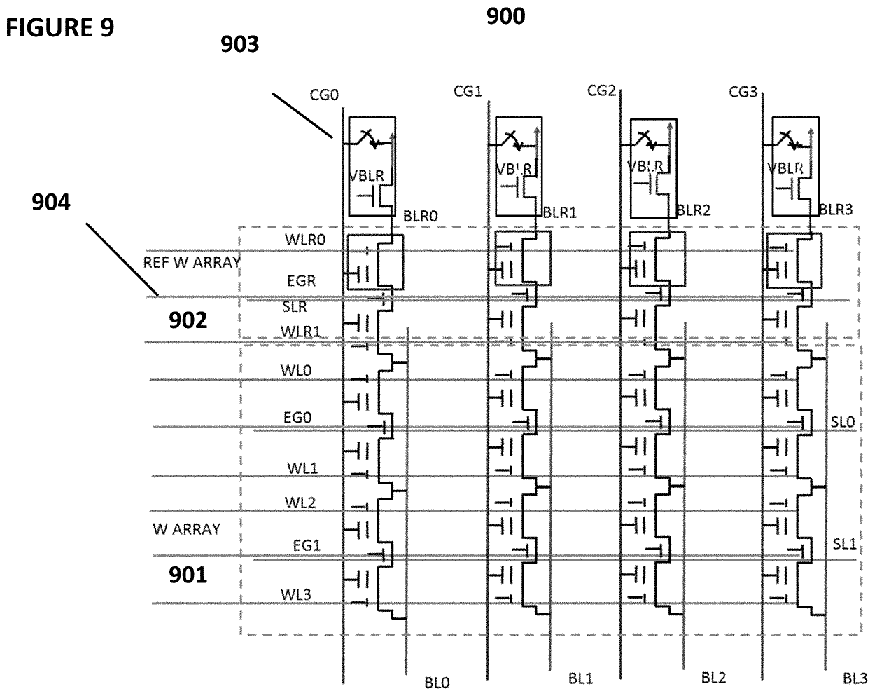

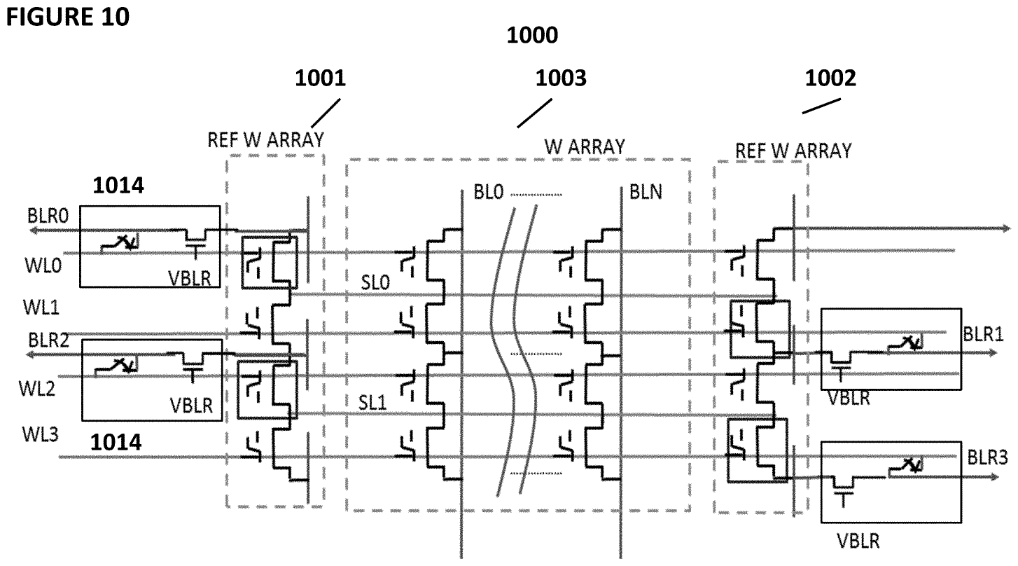

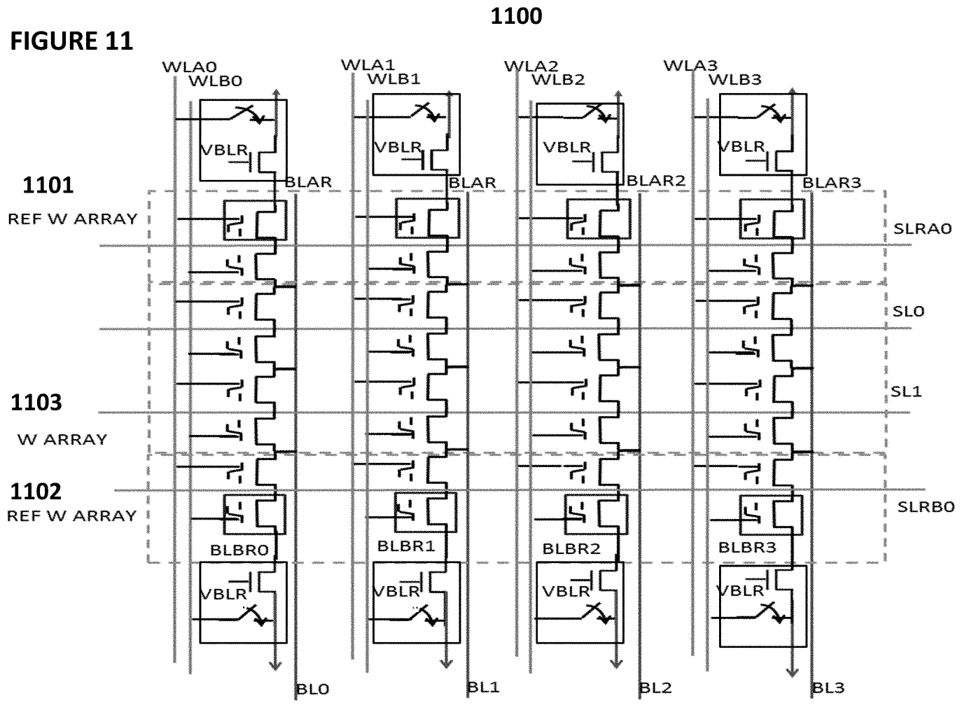

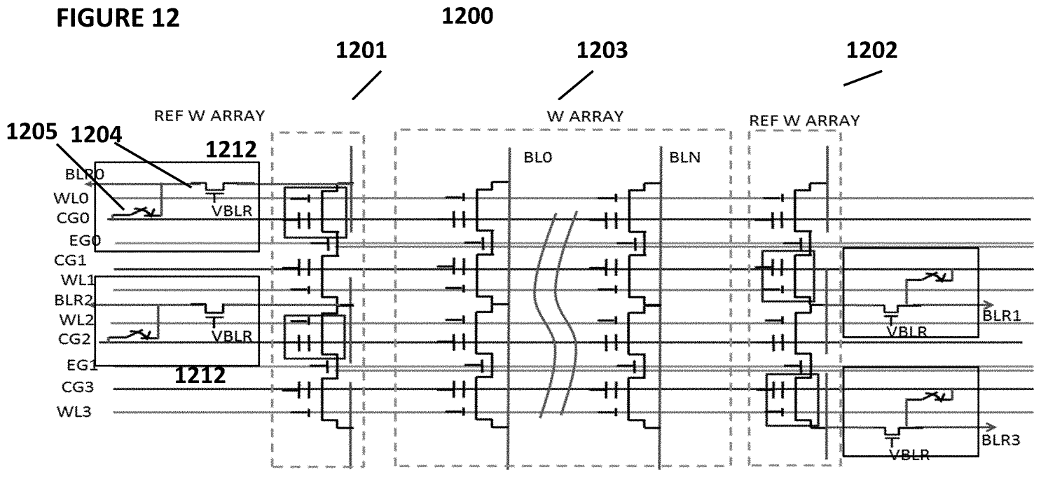

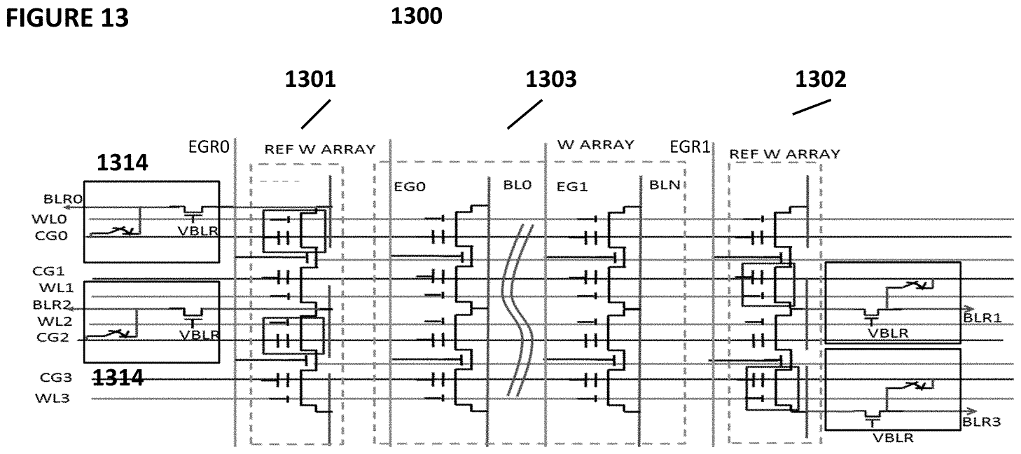

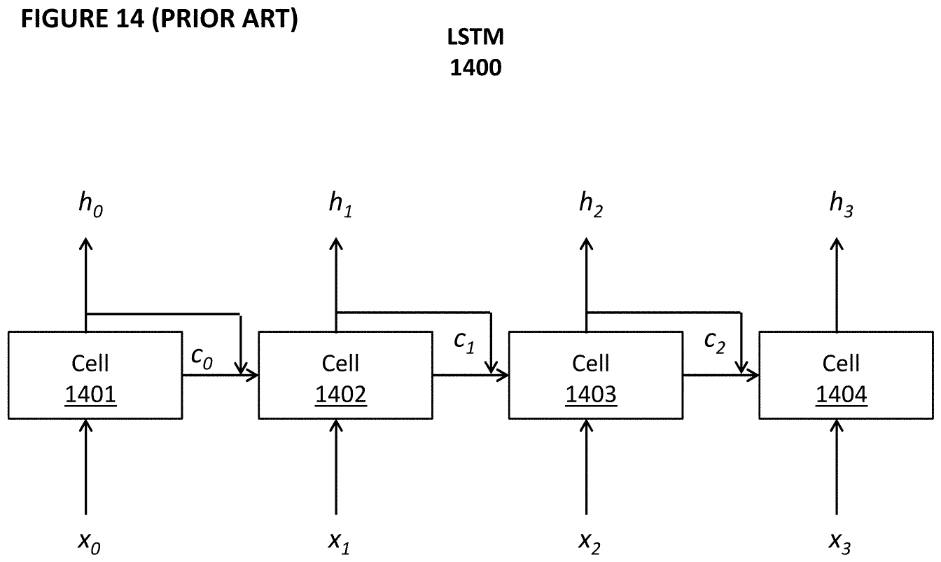

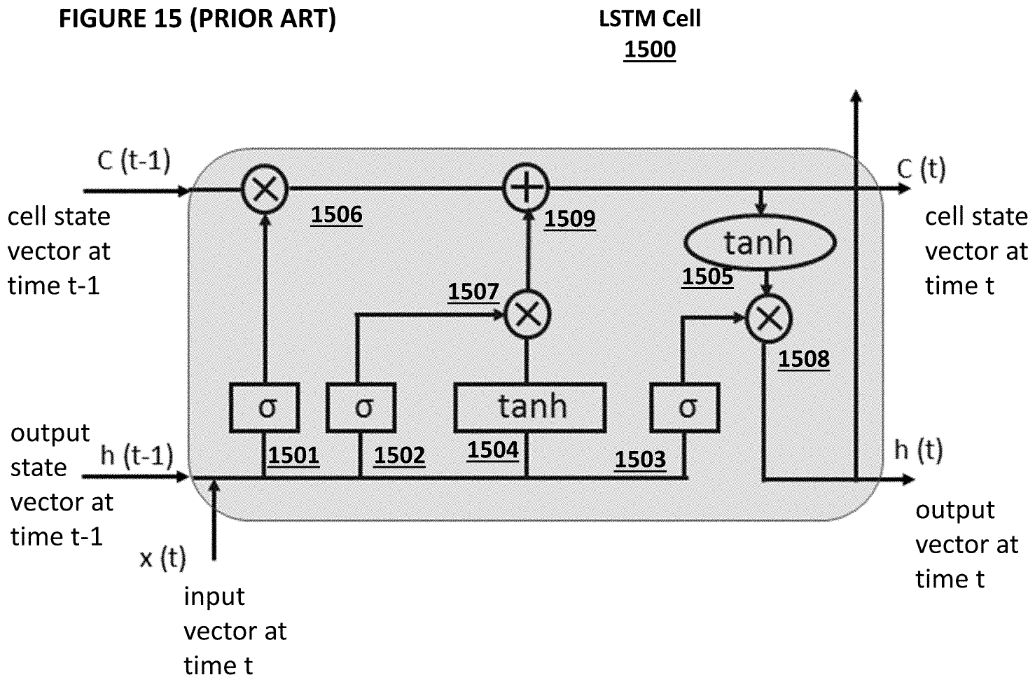

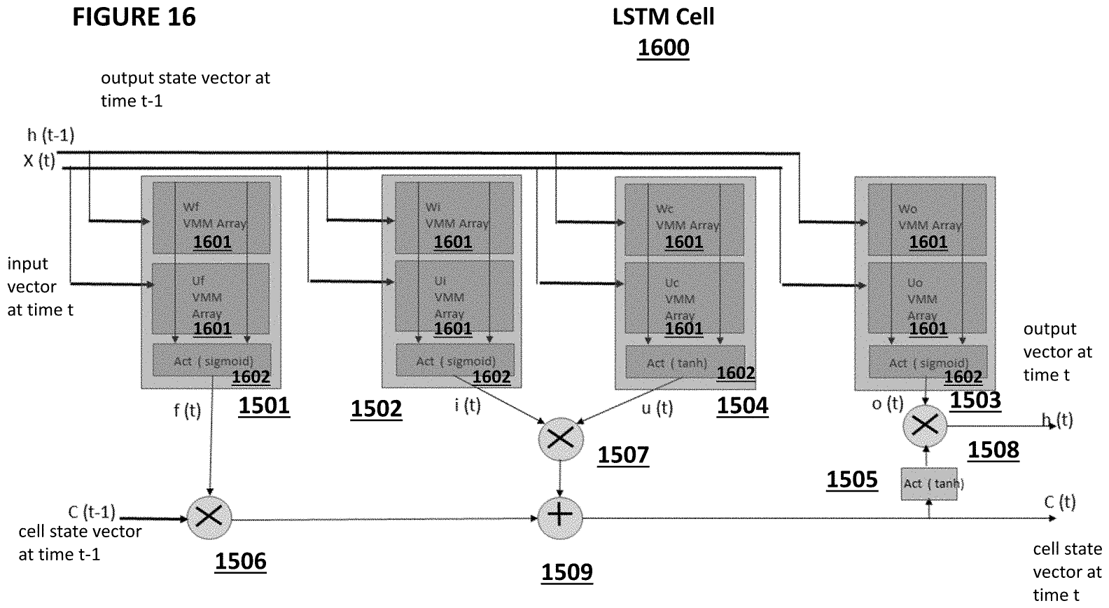

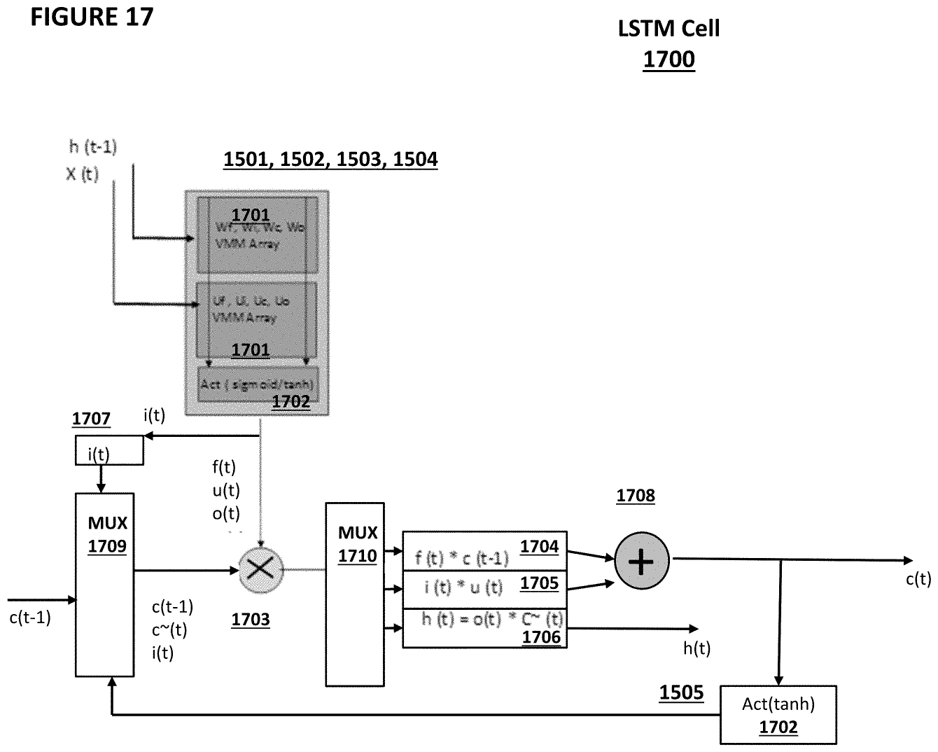

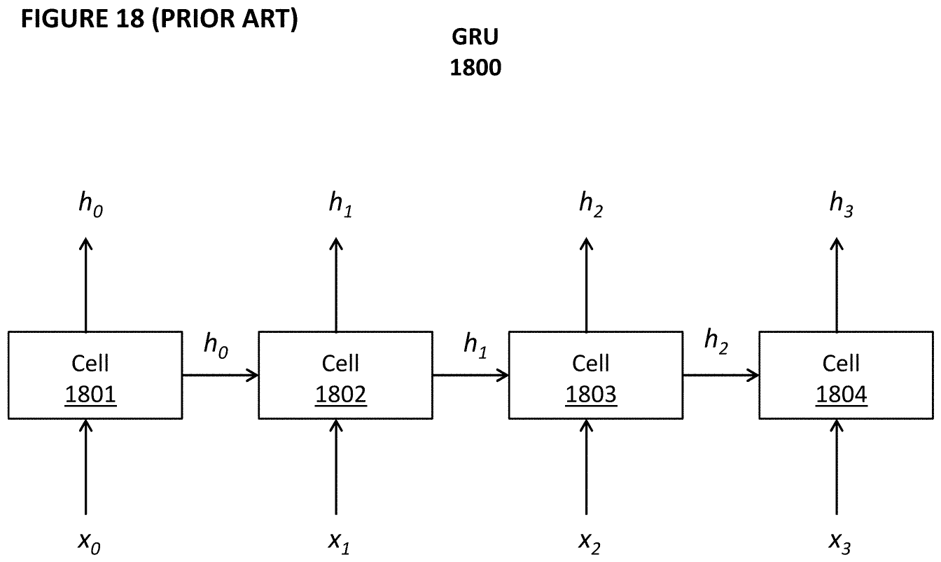

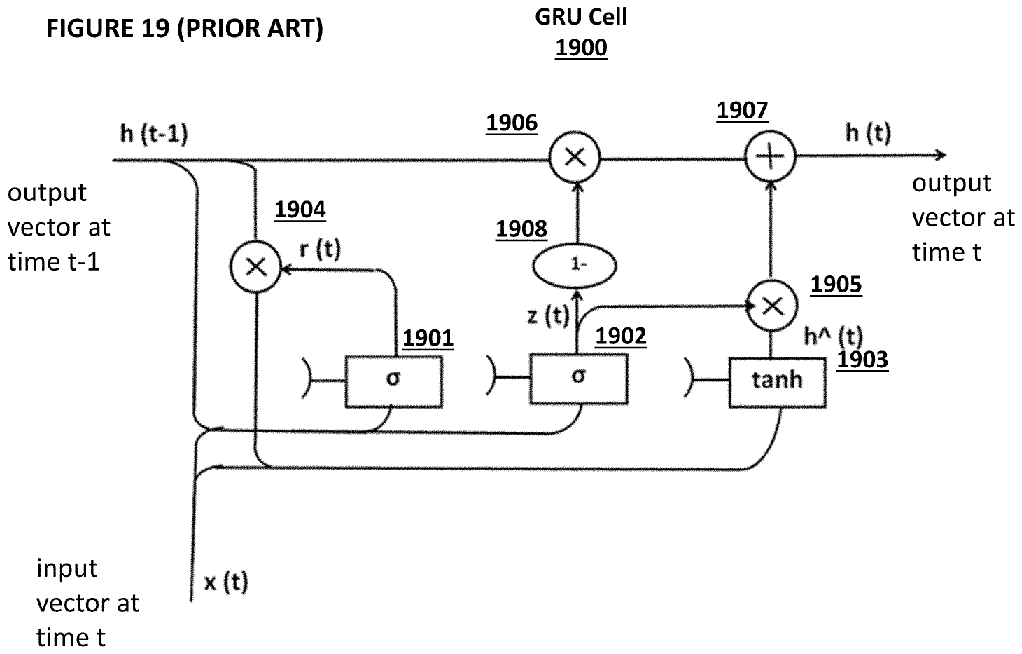

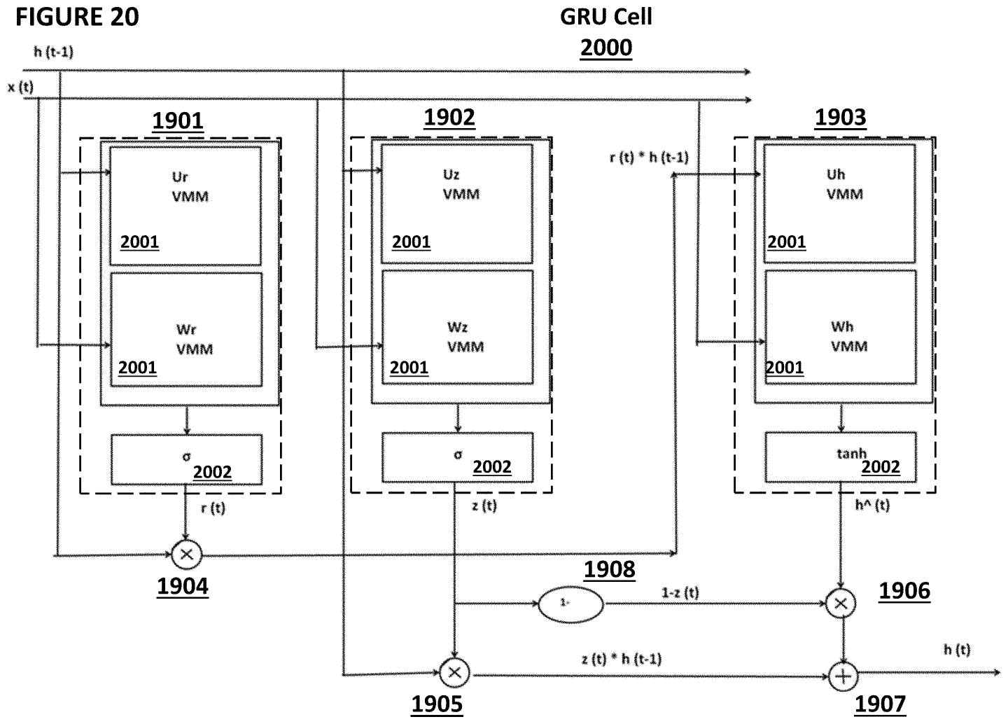

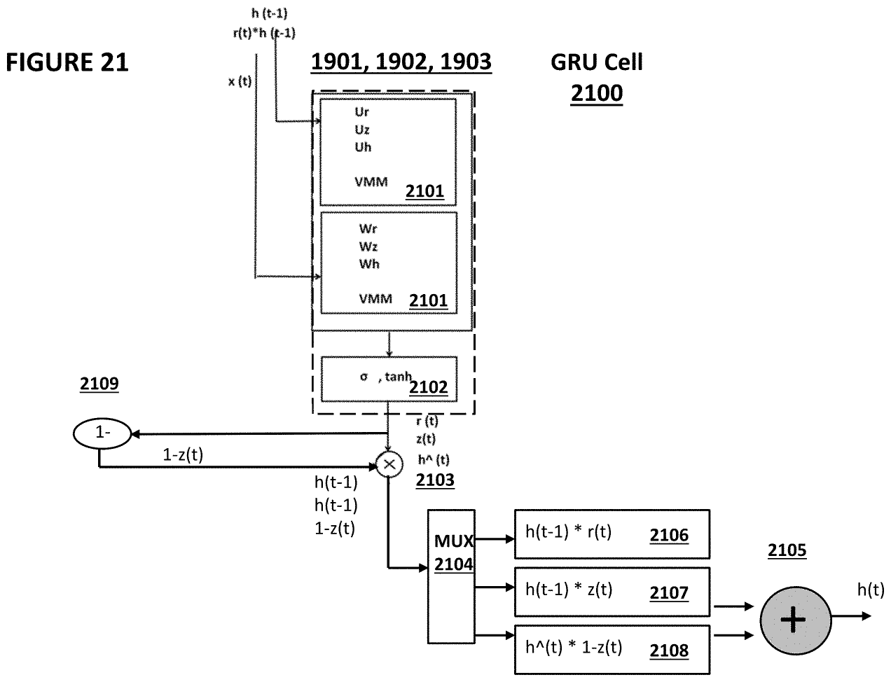

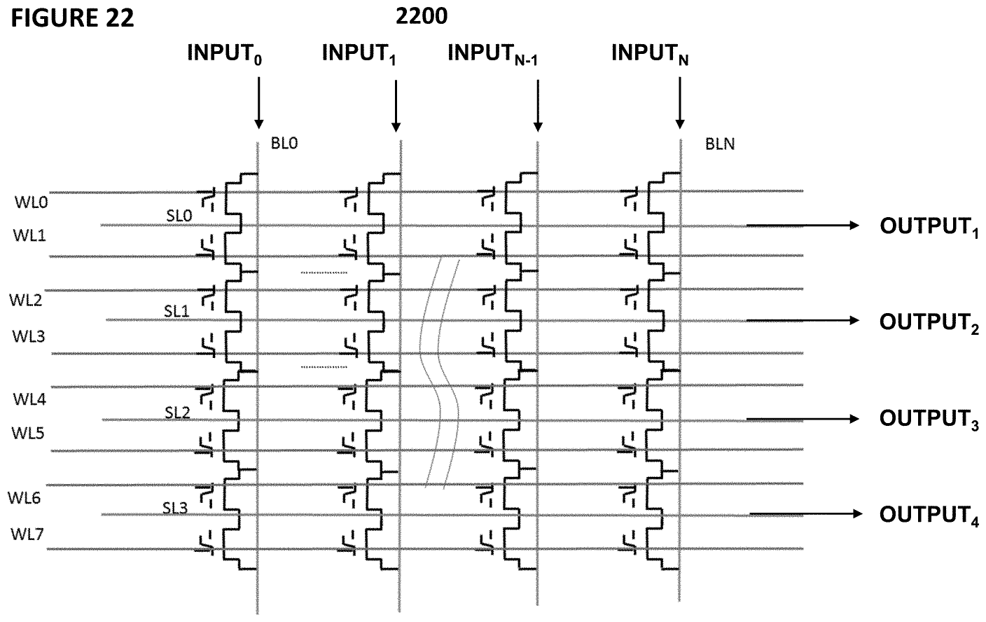

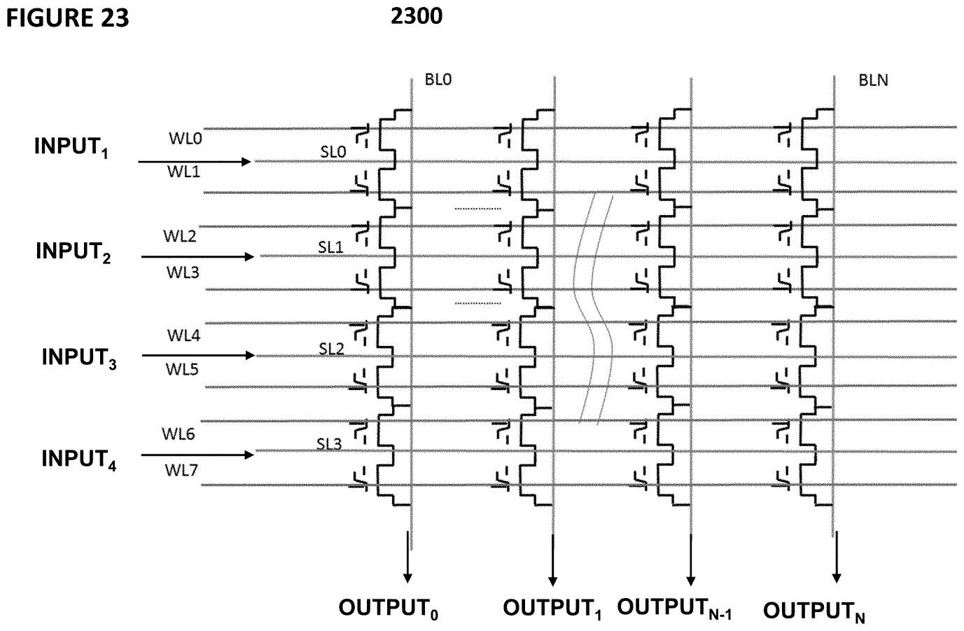

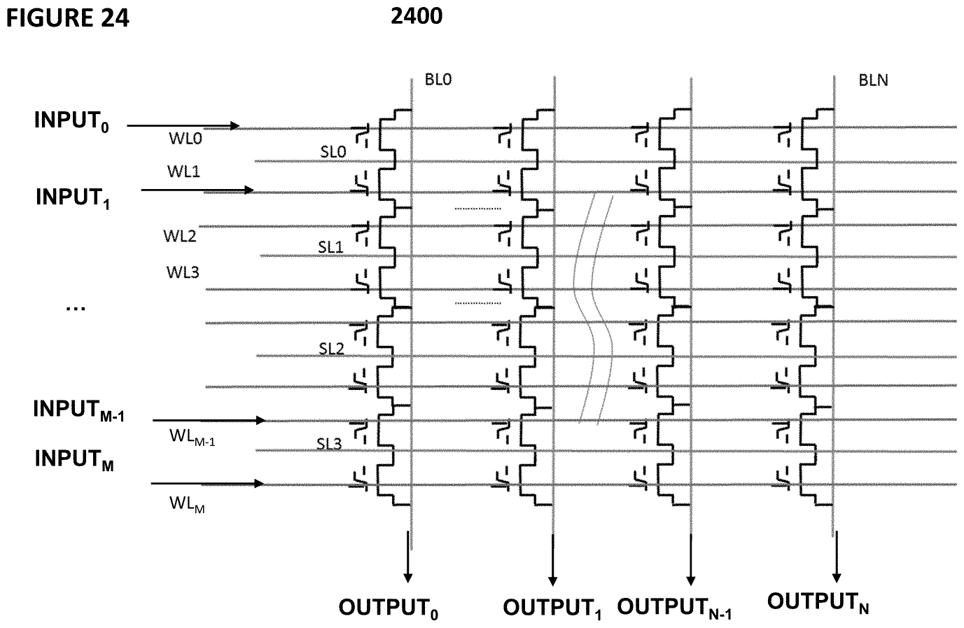

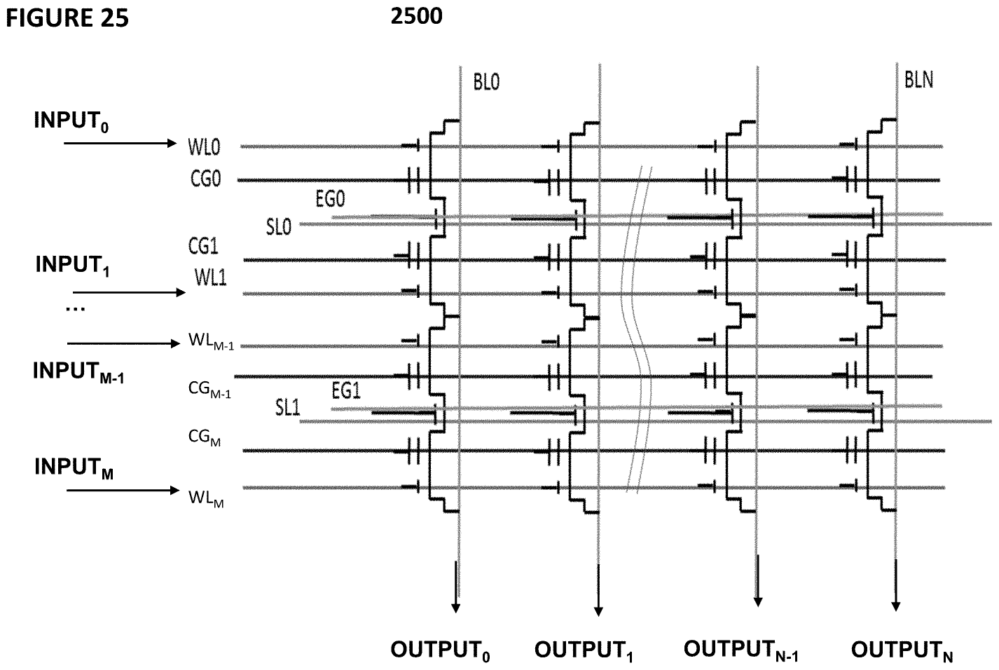

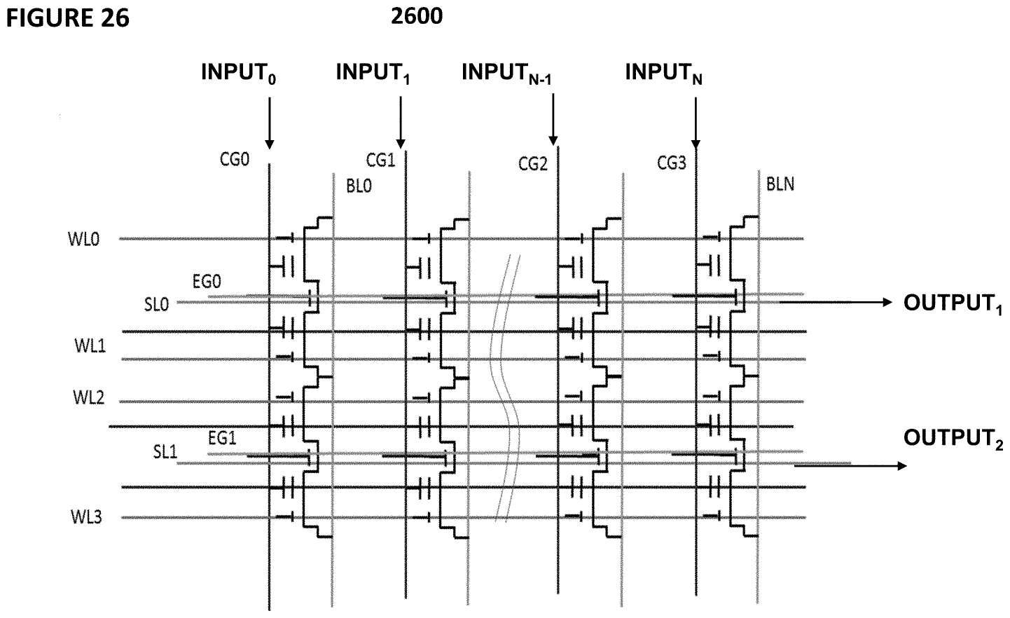

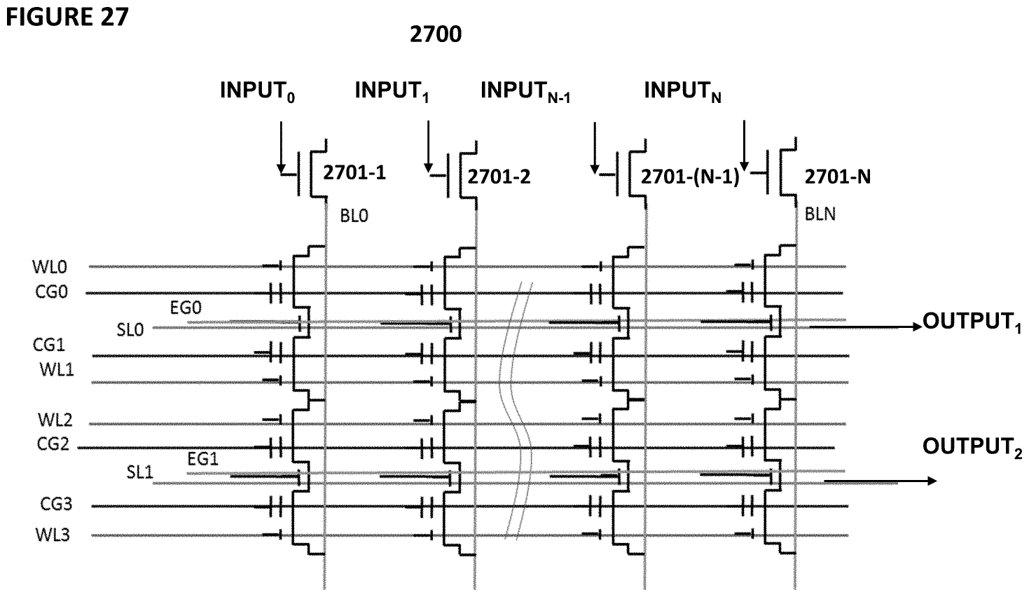

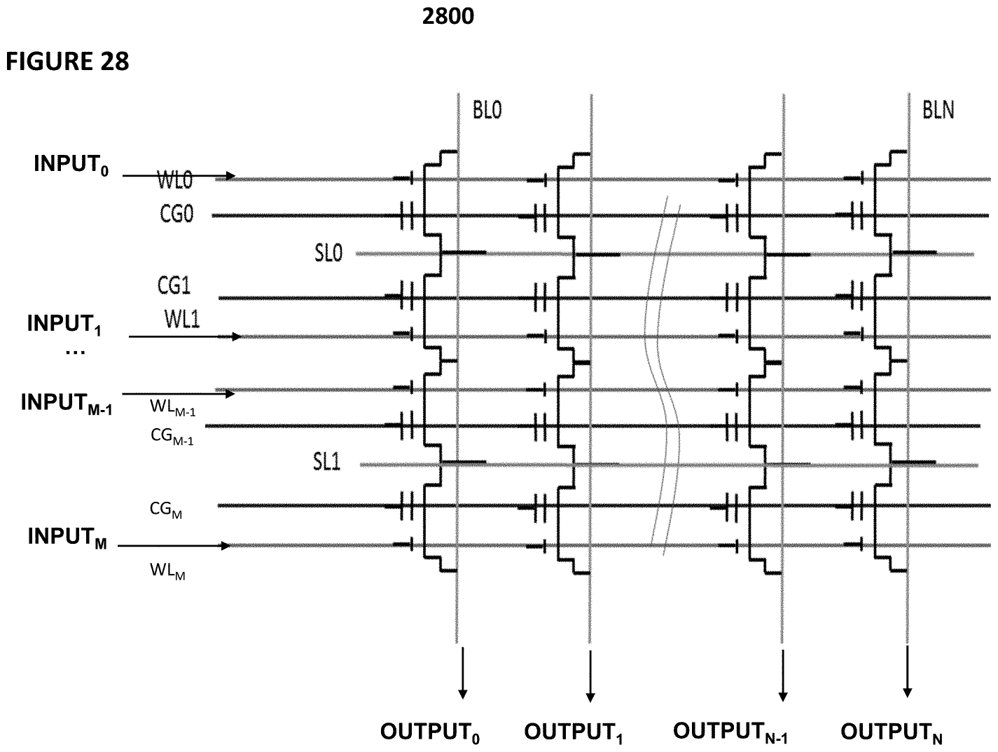

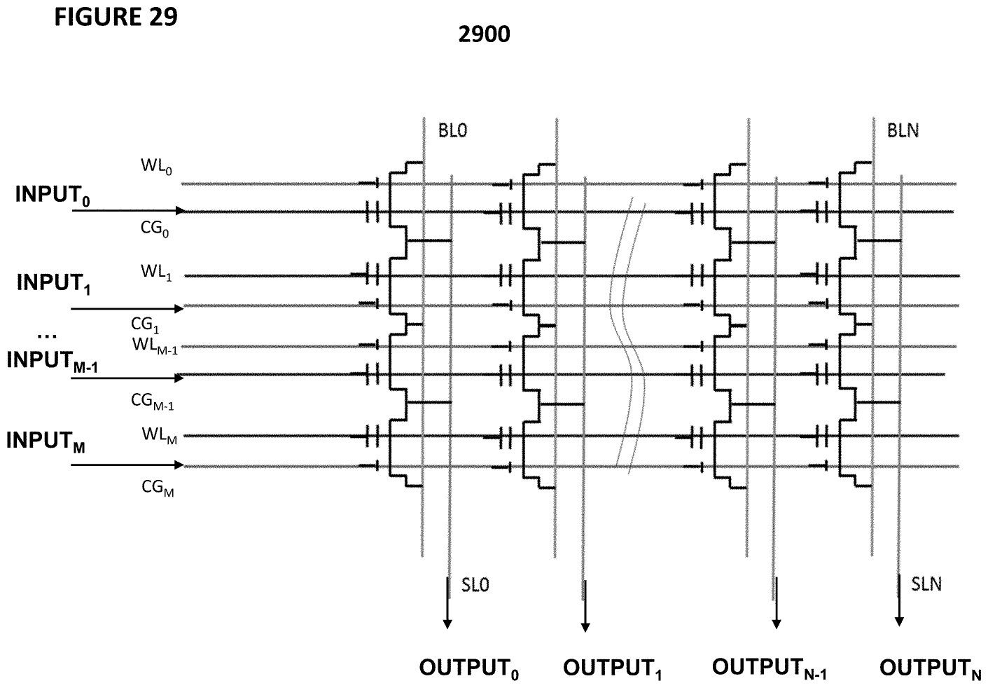

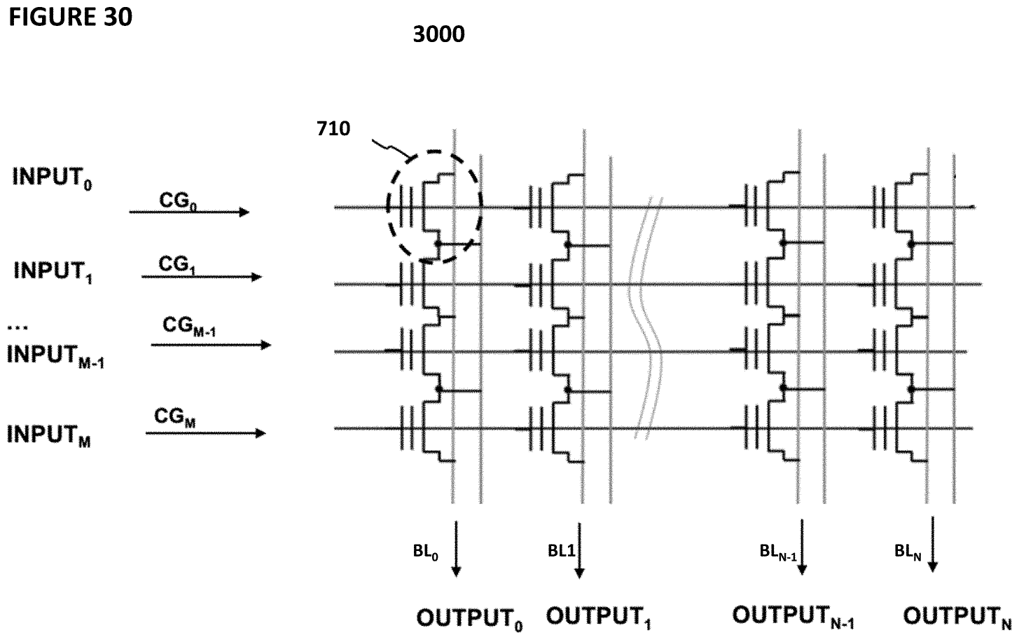

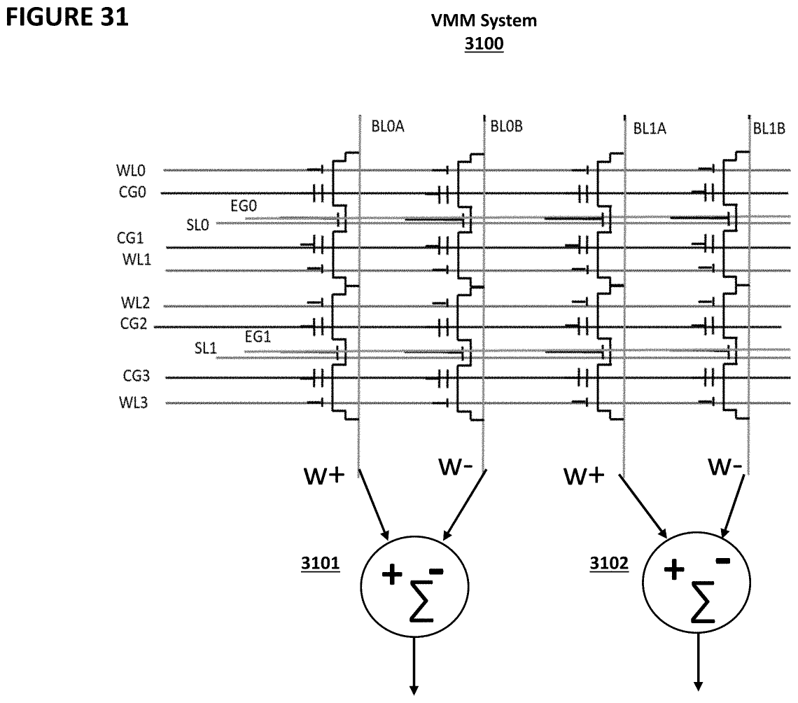

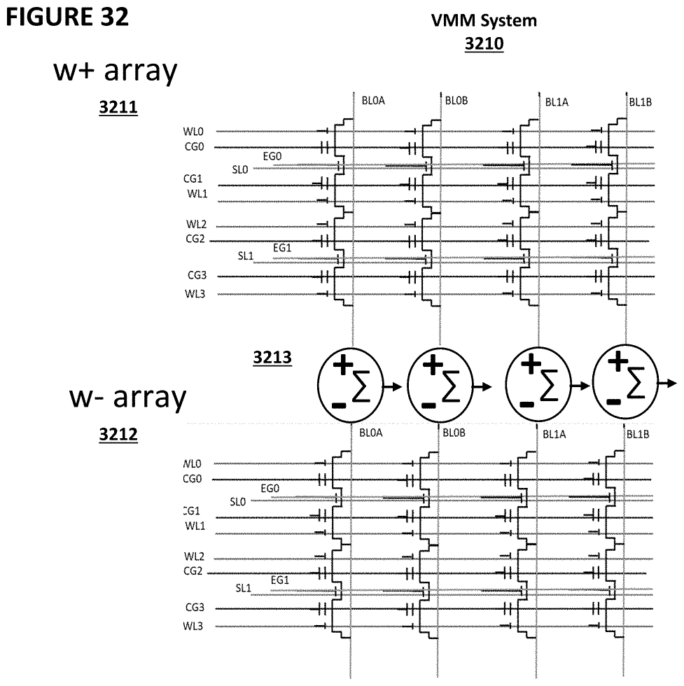

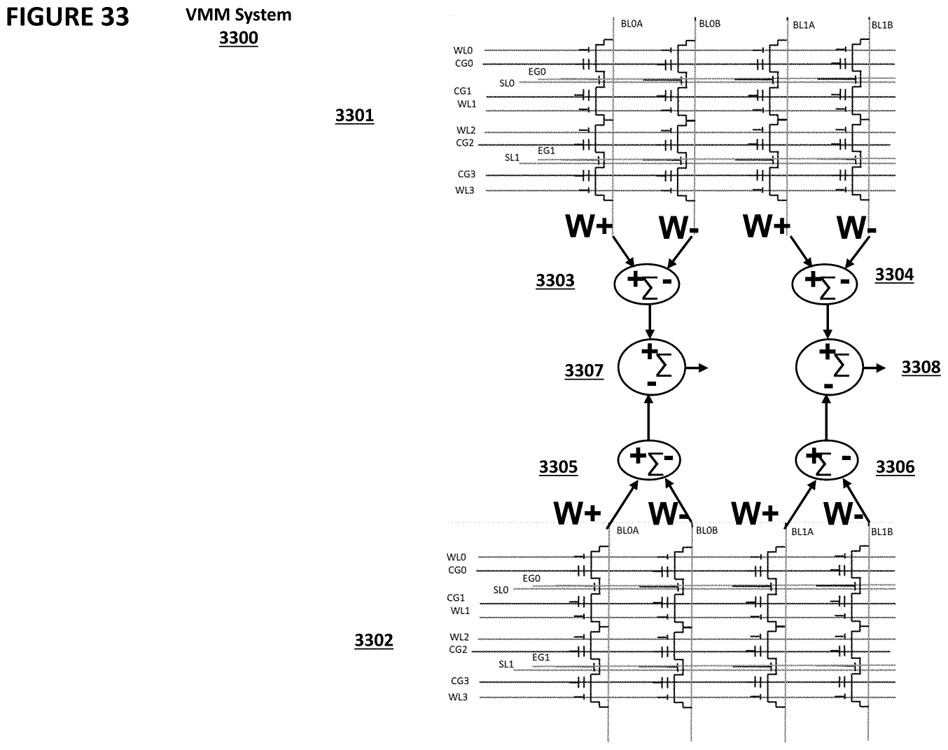

### DETAILED DESCRIPTION OF THE INVENTION

### 3D VMM System Architecture

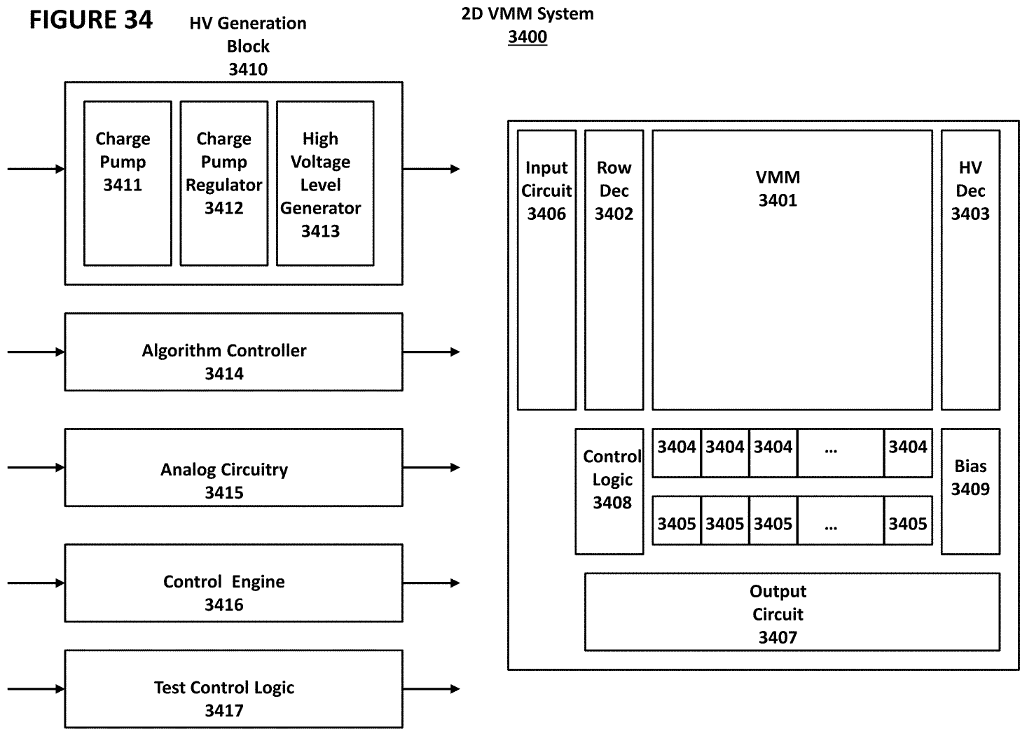

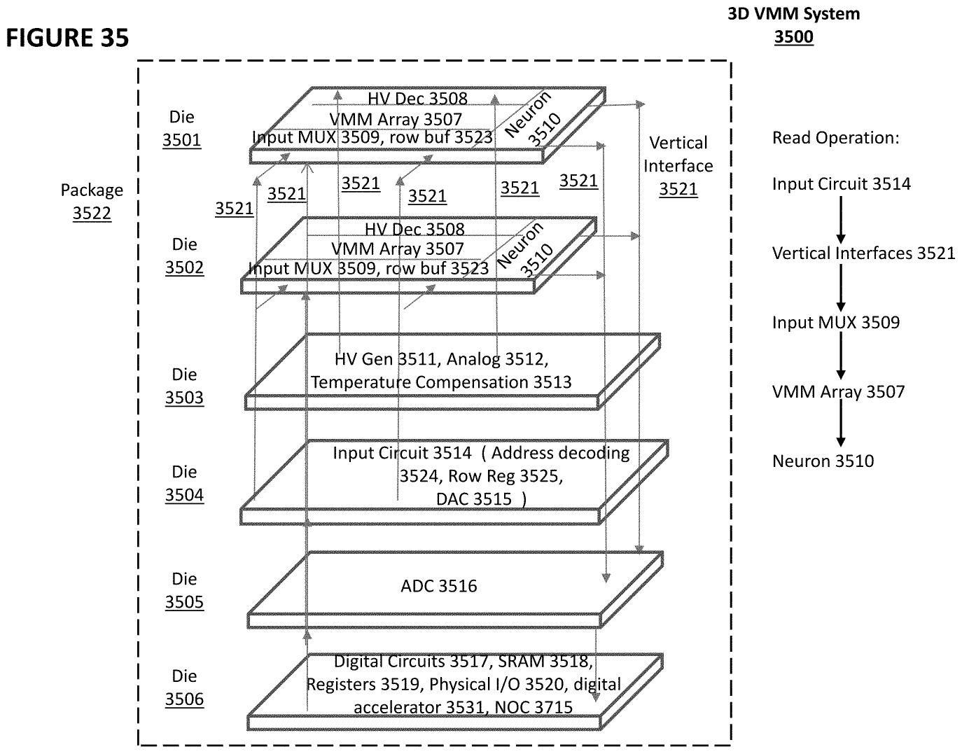

FIG. 35 depicts 3D VMM system 3500, which comprises a plurality of dies, such as dies 3501, 3502, 3503, 3504, 3505, and 3506, which are stacked vertically within package 3522 to form a packaged integrated circuit. 3D VMM system 3500 comprises certain functional blocks that are functionally similar to blocks contained in VMM system 3400 in FIG. 34, but the blocks may be located on different dies. Here, components contained in dies 3501 and 3502 share the components contained in dies 3503, 3504, 3505, and 3506.

In this example, die 3501 contains a respective VMM array 3507 (functionally similar to VMM 3401 in FIG. 34), a respective input multiplexor 3509, a respective row buffer 3523 (which can provide, for example, sampled-and-held buffered voltages to array inputs), a respective high voltage decoder 3508 (functionally similar to high voltage decoder 3403 in FIG. 34), and a respective neuron circuit 3510 (which can perform, for example, a scaling function of array output current, min/max limit function, differential output conversion, buffering, without limitation). Input multiplexor 3509 receives and applies analog input signals to VMM array 3507, and neuron circuit 3510 receives analog output signals that represent neuron outputs from VMM array 3507. The output signals can be sent to other blocks within 3D VMM system 3500.

Die 3502 also contains a respective VMM array 3507, a respective input multiplexor 3509, a respective row buffer 3522, a respective high voltage decoder 3508, and a respective neuron circuit 3510.

In this example, two dies (dies 3501 and 3502) contain respective VMM arrays 3507, but it is to be understood that additional dies that contain respective VMM arrays can be included.

Die 3503 contains high voltage generator 3511 (functionally similar to high voltage generation block 3410 in FIG. 34), analog circuitry 3512 (functionally similar to analog circuitry 3415 in FIG. 34), and temperature compensation circuit 3513. 3D VMM system 3500 may have thermal challenges that 2D VMM system 3400 does not have. Because dies 3501, 3502, 3503, 3504, 3505, and 3506 are stacked in a vertical configuration and contain different types of circuits, each die may experience different thermal operating conditions during operation. For example, certain die will become hotter than other die, and the rate of temperature increase may vary among dies. This introduces the possibility of inaccuracies due to thermal changes. Temperature compensation circuit 3513 compensates for changes in temperature that are experienced among the various dies. Optionally, one or more thermal sensors is located on each respective die to provide temperature data to temperature compensation circuit 3513. Temperature compensation circuit 3513 then alters trim or configuration settings to compensate for any changes in temperature. Temperature compensation circuit 3513 also compensates the temperature changes for each die, for example to compensate for cell current changes over temperature such as making resulting bitline (neuron) current approximately the same over temperature. Temperature compensation circuit 3513 is also used to for the neuron circuit 3510, DAC, and ADC circuits such as to make the operating dynamic range (e.g., output range for DAC, input range for the ADC, output range for the neuron circuit 3510) approximately the same over the temperature.

Die 3504 contains input circuit 3514 (functionally similar to input circuit 3406), which includes address decoding circuit 3524, row register 3525 (holding activation input values for array rows), and digital-to-analog converter (DAC) 3515. DAC 3515 receives digital signals from the row register 3525 and converts them into analog signals.

Die 3505 contains analog-to-digital converter (ADC) 3516. ADC 3516 receives analog signals and converts them into digital signals.

Die 3506 contains digital circuits 3517, static random access memory (SRAM) 3518, registers 3519, physical I/O connections 3520, digital accelerator 3531, and a network-on-chip (NOC) 3715. Die 3506 provides control functions for other dies. Digital circuits 3517 can include digital logic, micro-controllers, SIMD (single instruction multiple data) processor, and processors. SRAM 3518 and registers 3519 can be used to store system information and configuration information used by digital circuits 3517 or other circuits, or blocks in 3D VMM system 3500. Physical I/O connections 3520 provide IO interfaces to devices outside of VMM system 3500 (such as an external processing unit) or to another package 3522. Digital accelerator 3531 is used for certain neural networks or certain layers within a neural network where additional processing may be required, such as when a small activation size is present, where the weights stored in the cells are dynamic and not fixed, where a MAC operation needs to be performed, without limitation. NOC 3715 provides network routing functionality within 3D VMM system 3500, for example, by generating control signals to cause signals to be routed from one block to another block.

Respective ones of the plurality of dies are connected to one or more other dies within the plurality of dies through vertical interfaces 3521, which vertical interfaces 3521 respectively connect two or more dies together. In one example, vertical interfaces 3521 are implemented as a through-silicon via (TSV).

During a read operation of 3D VMM system 3500, a digital input is received by input circuit 3514. The digital input enables row registers 3525, which store activation inputs and applies a selected activation input in response to the digital input to DAC 3515 which DAC 3515 converts the digital outputs from the row registers 3525 into respective analog signals. The analog signal produced by DAC 3515 is provided by input circuit 3514 over one or more vertical interfaces 3521 to input multiplexor 3509 and row buffer 3523 on one, or more of dies 3501, 3502, which then applies the signals to one or more rows in the respective VMM array 3507, resulting in an output being generated by VMM array 3507. The output from the respective VMM array 3507 is received by the respective neuron circuit 3510, which provides a buffer function to drive the parasitic capacitance of the one or more vertical interfaces 3521 to which it connects. Neuron circuit 3510 provides analog signals over one or more vertical interfaces 3521 to ADC 3516 on die 3505, which ADC 3516 converts the analog signals into digital signals. Alternatively, the analog signals can bypass ADC 3516 and remain in analog form. The output of ADC 3516 is provided to a device external to 3D VMM system 3500 (such as a processing unit or graphics processing unit) through physical I/O 3520 or applied as inputs to a respective VMM array 3507 (representing another layer in the artificial neural network). Alternatively, the analog signals from neuron circuit 3510 can bypass ADC 3516 and remain in analog form and be applied as inputs to a respective VMM array 3507.

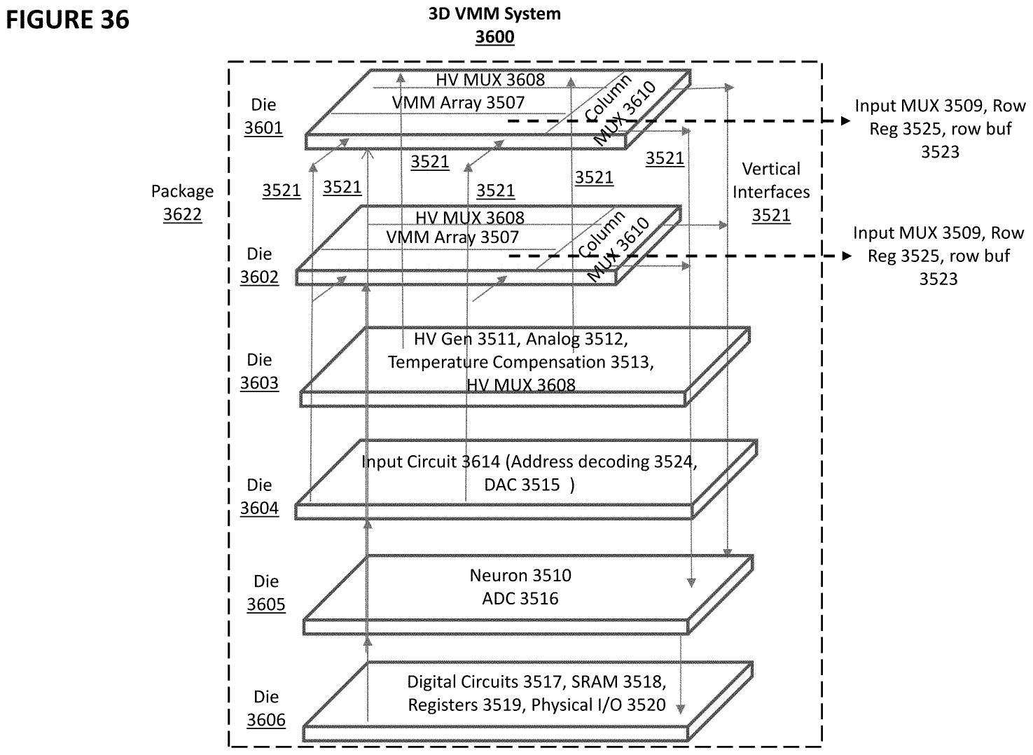

FIG. 36 depicts 3D VMM system 3600 comprising package 3622. 3D VMM system 3600 is similar to 3D VMM system 3500 and contains many of the same components, except for some differences in the placement of components and certain additional components. Items that are the same as in FIG. 35 contain the same item number as in FIG. 36. Here, components contained in dies 3601 and 3602 share the components contained in dies 3603, 3604, 3605, and 3606.

3D VMM system 3600 comprises a plurality of dies, such as dies 3601, 3602, 3603, 3604, 3605, and 3606, which are stacked vertically within common package 3522 to form a packaged integrated circuit.

In this example, die 3601 contains a respective VMM array 3507, a respective input multiplexor 3509, respective registers 3524 (holding the activation input values for array rows), respective row buffers 3523, a respective high voltage multiplexor 3608, and a respective column multiplexor 3610.

Die 3602 also contains a respective VMM array 3507, a respective input multiplexor 3509, respective registers 3524, respective row buffers 3523, a respective high voltage multiplexor 3608, and column multiplexor 3610.

In this example, two dies (dies 3601 and 3602) contain respective VMM arrays 3507, but it is to be understood that additional dies that contain VMM arrays can be included.

Die 3603 contains high voltage generator 3511, analog circuitry 3512, temperature compensation circuit 3513, and high voltage multiplexor 3608.

Die 3604 contains input circuit 3614 which includes address decoding 3524 and DAC 3515.

Die 3605 contains neuron circuit 3510 and ADC 3516.

Die 3606 contains digital circuits 3517, SRAM 3518, registers 3519, and physical I/O connections 3520.

Respective ones of the plurality of dies are connected to one or more other dies within the plurality of dies through respective vertical interfaces 3521.

During a read operation of 3D VMM system 3600, an input is received and an address is received by input circuit 3614. Address decoder 3524 decodes the address and provides the input over one or more vertical interfaces 3521 to a respective row register 3525 corresponding to the decoded address. The output of the respective row register 3525 is coupled over one or more vertical interfaces 3521 to DAC 3515 which converts the digital output bits received from row register 3525 into an analog signal, and provides the analog signal over one or more vertical interfaces 3521 to a respective input multiplexor 3509 and row buffer 3523. Row buffer 3523 applies the analog signal, buffered, to row inputs of the respective VMM array 3507 for the selected rows (such as array control gates or wordlines). The output from the respective VMM array 3507 (such as from array bitlines) is received by the respective column multiplexor 3610, and the output of the respective column multiplexor 3610 provides signals over one or more vertical interfaces 3521 to ADC 3516, on die 3605, which converts the analog signals into digital signals. Alternatively, the signals can bypass ADC 3516 and remain in analog form. The output of ADC 3516 is provided over one or more vertical interfaces 3521 to digital circuits 3517 (which can perform an activation function, a pooling function, or other network function) on die 3606, and the output of digital circuits 3517 may be provided to a device external to 3D VMM system 3600 (such as a processing unit or graphics processing unit) through physical I/O 3520 on die 3606 or to input circuit 3614 on die 3604, over a respective vertical interface 3521, as inputs to another respective VMM array 3507 (representing another layer in the artificial neural network).

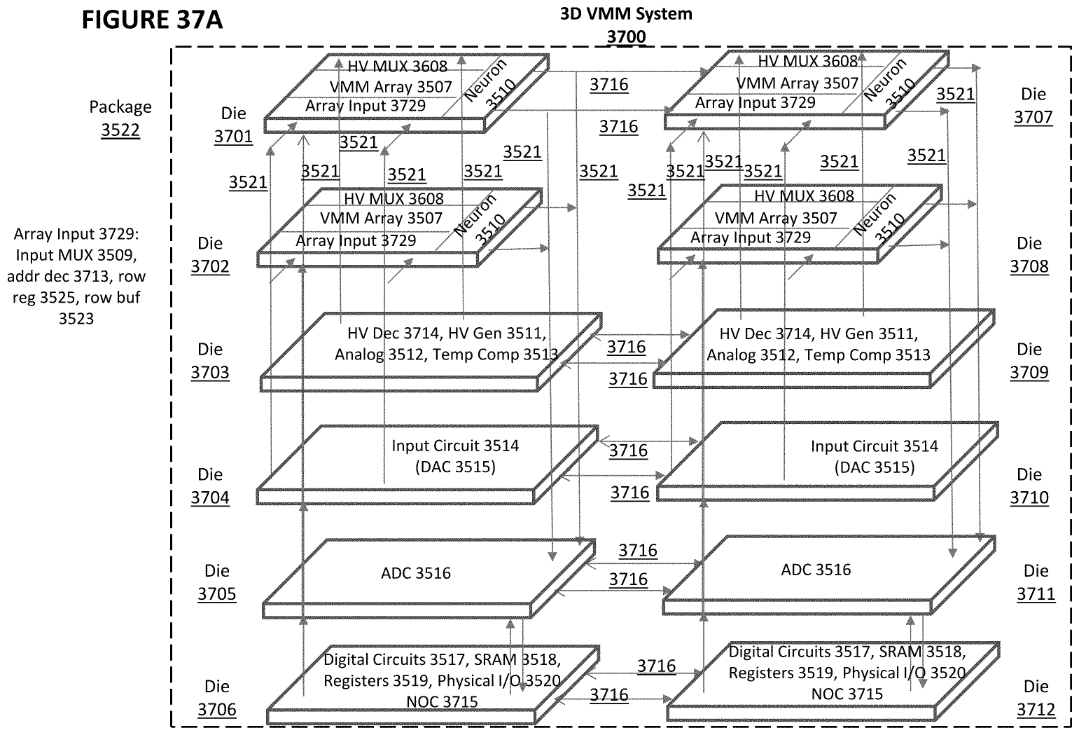

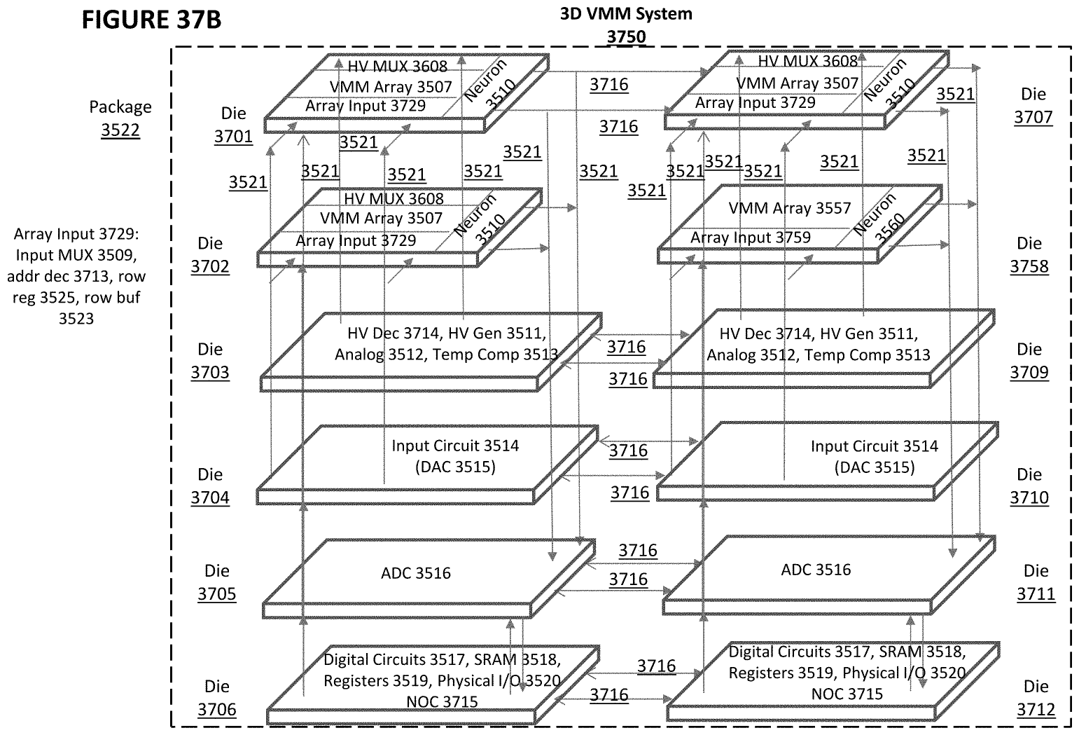

FIG. 37A depicts 3D VMM system 3700, which comprises a plurality of dies in two or more vertical stacks. In this example, the first vertical stack comprises dies 3701, 3702, 3703, 3704, 3705, and 3706, and the second vertical stack comprises dies 3707, 3708, 3709, 3710, 3711, and 3712, all of which are contained in a common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3701 and 3707 are the same die). Here, components contained in dies 3701 and 3702 share the components contained in dies 3703, 3704, 3705, and 3706, and components contained in dies 3707 and 3708 share the components contained in dies 3709, 3710, 3711, and 3712.

In the example shown, die 3701 and die 3707 each contain a respective VMM array 3507, a respective array input 3729 (which includes a respective input multiplexor 3509, a respective address decoder 3713, a respective row register 3525, and a respective row buffer 3523), a respective high voltage multiplexor 3608, and a respective neuron circuit 3510.

Die 3702 and die 3708 also each contain a respective VMM array 3507, a respective array input 3729 (which includes a respective input multiplexor 3509, a respective address decoder 3713, a respective row register 3525, and a respective row buffer 3523), a respective high voltage multiplexor 3608, and a respective neuron circuit 3510.

In this example, four dies (dies 3701, 3702, 3707, and 3708) contain respective VMM arrays 3507, but it is to be understood that additional dies that contain VMM arrays can be included.

Die 3703 and die 3709 each contain a respective high voltage decoder 3714, a respective high voltage generator 3511, a respective analog circuitry 3512, and a respective temperature compensation circuit 3513.

Die 3704 and die 3710 each contain a respective input circuit 3514 which includes a respective DAC 3515.

Die 3705 and die 3711 each contain a respective ADC 3516.

Die 3706 and die 3712 each contain respective digital circuits 3517, a respective SRAM 3518, respective registers 3519, respective physical I/O connections 3520, and respective NOC (network-on-chip) connections 3715.

Respective ones of the plurality of dies are connected to one or more other dies within the plurality of dies through one or more vertical interfaces 3521 or horizontal interfaces 3716, which respectively connect two or more dies together. In one example, vertical interfaces 3521 are respectively a through-silicon via (TSV). In one example, horizontal interfaces 3716 are respectively a redistribution layer (RDL) connection.

During a read operation of 3D VMM system 3700, a digital input is received by a respective input circuit 3514, which converts the digital input to an analog signal via its respective DAC 3515, and the output of the respective DAC 3515 is coupled to the row register 3525 of the respective array input 3729 via the respective vertical interface(s) 3521 and/or horizontal interface(s) 3716. The output of row register 3525 of the respective array input 3729 is provided to input multiplexor 3509 and row buffer 3523, which then applies the signals to one or more rows in VMM array 3507. The output from the respective VMM array 3507 is received by the respective neuron circuit 3510, which neuron circuit 3510 provides a buffer function to drive the parasitic capacitance of the one or more vertical interfaces 3521 or horizontal interfaces 3716 to which it connects. Neuron circuit 3510 provides buffered analog signals over one or more vertical interfaces 3521 or horizontal interfaces 3716 to a respective ADC 3516, which converts the analog signals into digital signals. The output of ADC 3516 is provided to respective digital circuits 3517 (which performs an activation function, pooling function, or network function) and the output of the respective digital circuits 3517 may be provided to a device external to 3D VMM system 3700 (such as a processing unit or graphics processing unit) through respective physical I/O 3520 or to a respective input circuit 3514 to be converted by the respective DAC 3515, and the output of the respective input circuit 3514 is coupled to another VMM array 3507 (representing another layer in the artificial neural network) or to another package 3522 through a respective physical I/O 3520.=

FIG. 37B depicts 3D VMM system 3750 which is similar to the 3D VMM system 3750 except it has another type of VMM array, shown on die 3758 as VMM array 3557, which VMM array 3557 comprises static RAM cells or dynamic RAM cells.

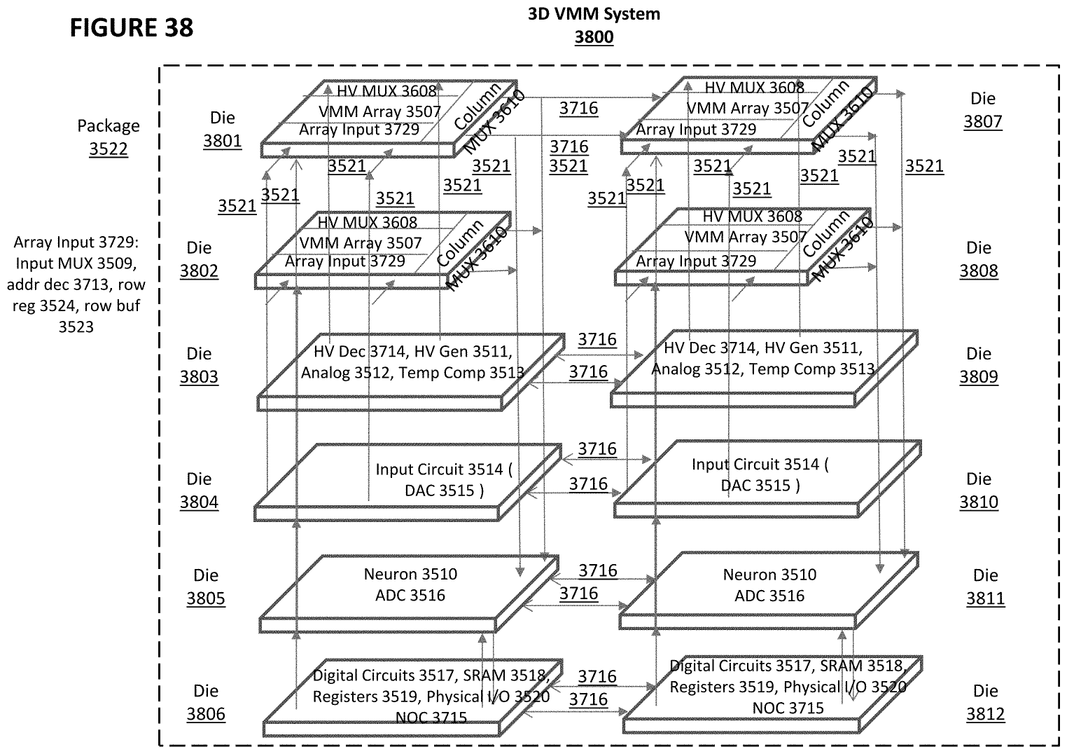

FIG. 38 depicts 3D VMM system 3800, which comprises a plurality of dies in two vertical stacks. It is possible to have more than two stacks. In this example, the first vertical stack comprises dies 3801, 3802, 3803, 3804, 3805, and 3806, and the second vertical stack comprises dies 3807, 3808, 3809, 3810, 3811, and 3812, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3801 and 3807 are the same die). Here, components contained in dies 3801 and 3802 share the components contained in dies 3803, 3804, 3805, and 3806, and components contained in dies 3807 and 3808 share the components contained in dies 3809, 3810, 3811, and 3812.

In the example shown, die 3801, 3802, 3807 and die 3808 each contain a respective VMM array 3507, a respective array input 3729, a respective high voltage multiplexor 3608, a respective column multiplexor 3610, and a respective array input circuit 3729. Respective array inputs 3729 comprise an input multiplexor 3509, and address decoder 3713, a row register 3524 and a row buffer 3523.

In this example, four dies (dies 3801, 3802, 3807, and 3808) contain VMM arrays, but it is to be understood that additional dies that contain VMM arrays can be included.

Die 3803 and die 3809 respectively contain a high voltage decoder 3714, a high voltage generator 3511, an analog circuitry 3512, and a temperature compensation circuit 3513.

Die 3804 and die 3810 respectively contain an input circuit 3514 which includes DAC 3515.

Die 3805 and die 3811 respectively contain ADC 3516, and neuron circuit 3510.

Die 3806 and die 3812 respectively contain digital circuits 3517, an SRAM 3518, registers 3519, physical I/O connections 3520, and NOC connections 3715.

The plurality of dies are respectively connected to one or more other dies within the plurality of dies through one or more vertical interfaces 3521 or horizontal interfaces 3716, which respectively connect two or more dies together. In one example, respective vertical interfaces 3521 are implemented as a through-silicon via (TSV). In one example, respective horizontal interface 3716 are implemented as a redistribution layer (RDL) connection.

During a read operation of 3D VMM system 3800, a digital input is received by input circuit 3514, which uses DAC 3515 to convert the digital input into analog form and provide the analog signal to the respective array input circuit 3729 via the respective vertical interface(s) 3521 and/or horizontal interface(s) 3716. Array input circuit 3729 receives the analog signals from the input circuit and addresses and then applies the analog signal to the selected rows, responsive to the addresses, in VMM array 3507. The output from VMM array 3507 is received by column multiplexor 3610, which provides analog signals over one or more vertical interfaces 3521 or horizontal interfaces 3716 to ADC 3516, which converts the analog signals into digital signals. Alternatively, the analog signals can bypass ADC 3516 and remain in analog form. The output of ADC 3516 is provided over one or more vertical interfaces 3521 or horizontal interfaces 3716 to digital circuit 3517 (which can perform an activation function, a pooling function, or other network function) and the output of digital circuit 3517 can be provided to a device external to 3D VMM system 3800 (such as a processing unit or graphics processing unit) through physical I/O 3520 or to input circuits 3514 of other VMM array 3507 (representing another layer in the artificial neural network) or to another package 3522 through physical I/O 3520.

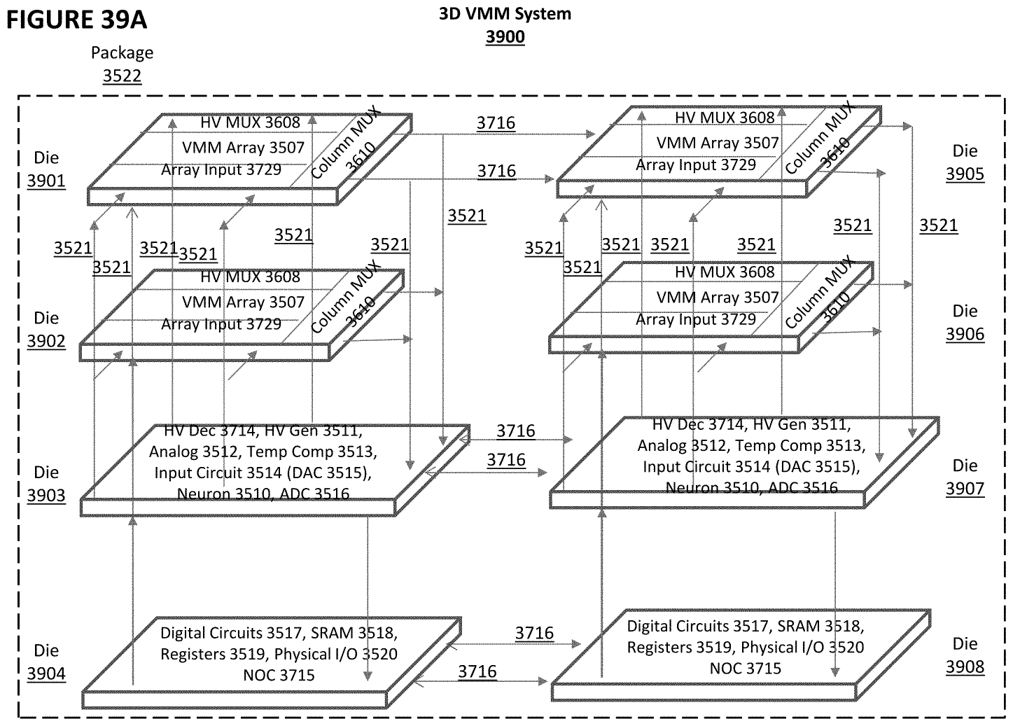

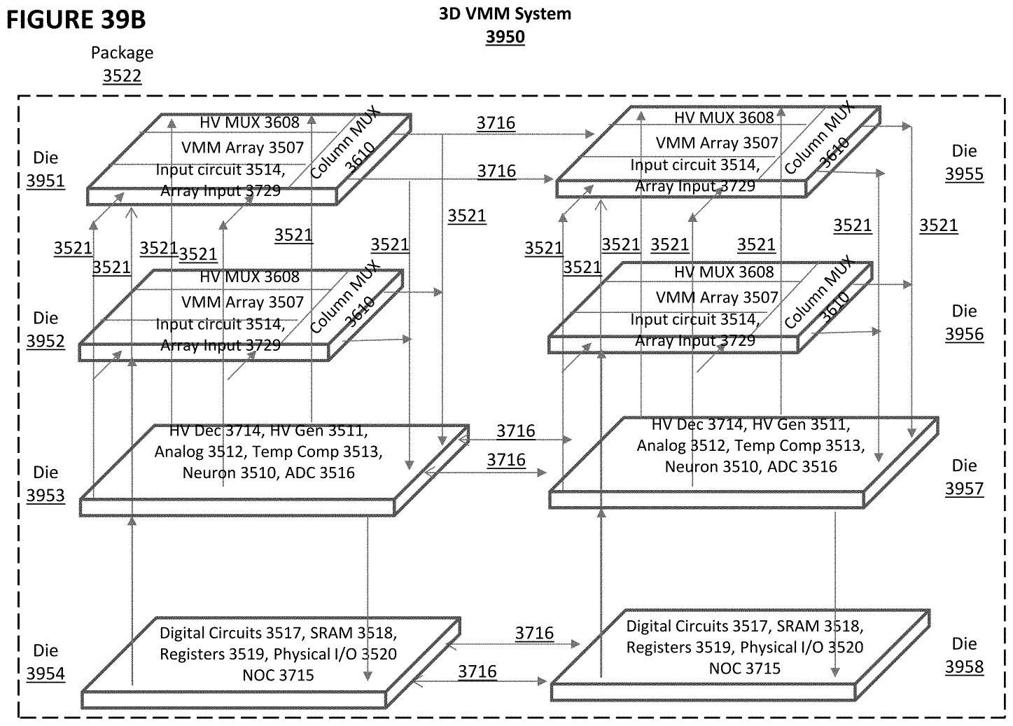

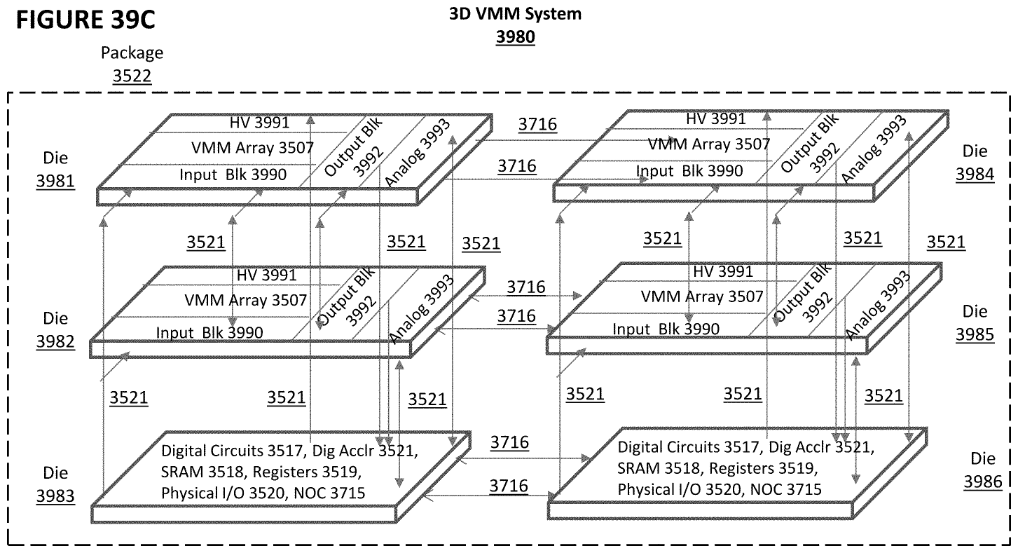

FIG. 39A depicts 3D VMM system 3900, which comprises a plurality of dies in two vertical stacks. In this example, the first vertical stack comprises dies 3901, 3902, 3903, and 3904, and the second vertical stack comprises dies 3905, 3906, 3907, and 3908, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3901 and 3905 are the same die). Here, components contained in dies 3901 and 3902 share the components contained in dies 3903 and 3904, and components contained in dies 3905 and 3906 share the components contained in dies 3907 and 3908.

In the example shown, die 3901, 3902, 3905 and die 3906 respectively contain a VMM array 3507, an array input 3729, a high voltage multiplexor 3608, and a column multiplexor 3610.

In this example, four dies (dies 3901, 3902, 3903, and 3904) contain VMM arrays, but it is to be understood that additional dies that contain VMM arrays can be included.

Die 3903 and die 3907 respectively contain a high voltage decoder 3714, a high voltage generator 3511, an analog circuitry 3512, a temperature compensation circuit 3513, an input circuit 3514 which includes DAC 3515, a neuron circuit 3510, and ADC 3516.

Die 3904 and die 3908 respectively contain digital circuits 3517, an SRAM 3518, registers 3519, physical I/O connections 3520, and NOC connections 3715.

The plurality of dies are respectively connected to one or more other dies within the plurality of dies through one or more vertical interfaces 3521 or horizontal interfaces 3716, which respectively connect two or more dies together.

During a read operation of 3D VMM system 3900, a digital input is received by input circuit 3514, which input circuit 3514 uses DAC 3515 to convert the digital input into analog form and provide the analog signal to the respective array input circuit 3729 via the respective vertical interface(s) 3521 and/or horizontal interface(s) 3716. Array input circuit 3729 receives analog signals from the input circuit and addresses, and, responsive to the received addresses, applies the analog signal to the selected rows in VMM array 3507. The output from VMM array 3507 is received by column multiplexor 3610, which provides analog signals over one or more vertical interfaces 3521 or horizontal interfaces 3716 to ADC 3516, which converts the analog signals into digital signals. Alternatively, the analog signals can bypass ADC 3516 and remain in analog form. The output of ADC 3516 is provided to digital circuits 3517 via the respective vertical interface(s) 3521 and/or horizontal interface(s) 3716, and then provided to a device external to 3D VMM system 3900 (such as a processing unit or graphics processing unit) through physical I/O 3520 or to input circuit 3514 to be applied as inputs to VMM array 3507 (representing another layer in the artificial neural network) or to another package 3522 through physical I/O 3520.

FIG. 39B depicts 3D VMM system 3950 which is similar to that of the FIG. 39A except that dies 3951, 3952, 3955, and 3956 now has both input circuits 3514 and array input 3729. 3D VMM system 3950 comprises package 3522 and dies 3951, 3952, 3953, 3954, 3955, 3956, 3957, and 3958. The plurality of dies are respectively connected to one or more other dies within the plurality of dies through one or more vertical interfaces 3521 or horizontal interfaces 3716, which respectively connect two or more dies together.

FIG. 39C depicts 3D VMM system 3980, which comprises a plurality of dies in two vertical stacks. In this example, the first vertical stack comprises dies 3981, 3982, 3983, and the second vertical stack comprises dies 3984, 3985, and 3986, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3981 and 3984 are the same die). Here, components contained in dies 3981 and 3982 share the components contained in dies 3983, and components contained in dies 3984 and 3985 share the components contained in dies 3986.

In the example shown, die 3981, 3982, 3984 and die 3985 respectively contain a VMM array 3507, a high voltage block 3991, an input block 3990, an output block 3992 and an analog block 3993. Input block 3990 may include input circuit 3514, DAC 3515, array input circuit 3729. High voltage block 3991 may include high voltage multiplexor 3608 and high voltage decoder 3714. Output block 3992 may include column multiplexor 3610, neuron circuit 3510, and ADC 3516. Analog block 3993 may include high voltage generator 3511, analog circuitry 3512, and temperature compensation circuity 3513.

Die 3983 and die 3986 each contains digital circuits 3517, SRAM 3518, registers 3519, physical I/O connections 3520, digital accelerator 3521 (used for multiple and accumulate (MAC) function digitally) and NOC connections 3715.

The plurality of dies are respectively connected to one or more other dies within the plurality of dies through one or more vertical interfaces 3521 or horizontal interfaces 3716, each of which respectively connects two or more dies together.

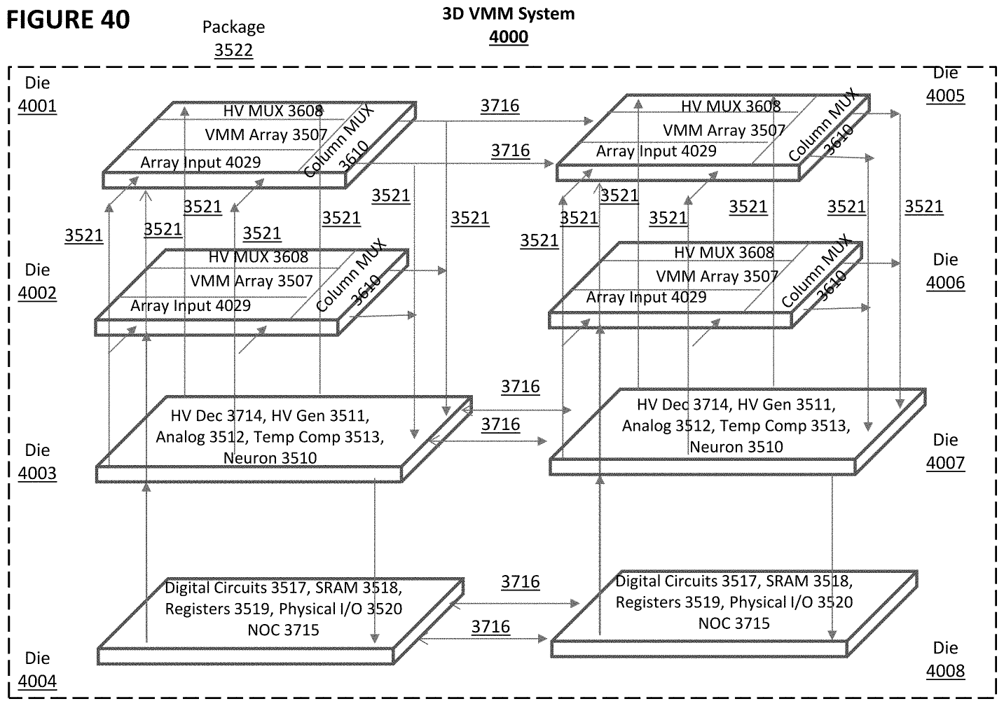

FIG. 40 depicts 3D VMM system 4000, which comprises a plurality of dies in two vertical stacks. In this example, the first vertical stack comprises dies 4001, 4002, 4003, and 4004, and the second vertical stack comprises dies 4005, 4006, 4007, and 4008, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 4001 and 4005 are the same die). Here, components contained in dies 4001 and 4002 share the components contained in dies 4003 and 4004, and components contained in dies 4005 and 4006 share the components contained in dies 4007 and 4008.

In the example shown, die 4001, 4002, 4005 and 4006 respectively contain a VMM array 3507, an array input 4029 (which includes input multiplexor 3509 and/or decoder 3713—not shown), a high voltage multiplexor 3608, and a column multiplexor 3610.

In this example, four dies (dies 4001, 4002, 4003, and 4004) contain VMM arrays, but it is to be understood that additional dies that contain VMM arrays can be included.

Die 4003 and die 4007 respectively contain a high voltage decoder 3714, a high voltage generator 3511, an analog circuitry 3512, a temperature compensation circuit 3513, and a neuron circuit 3510.

Die 4004 and die 4008 respectively contain a digital circuits 3517, an SRAM 3518, registers 3519, physical I/O connections 3520, and NOC connections 3715.

Unlike VMM system 3900, VMM system 4000 does not contain DAC 3515, and ADC 3516 because the inputs and outputs are kept in analog form and not converted between analog and digital form.

The plurality of dies are respectively connected to one or more other dies within the plurality of dies through one or more vertical interfaces 3521 or horizontal interfaces 3716, which respectively connect two or more dies together.

During a read operation of 3D VMM system 4000, an analog input (such as a voltage, a current, or a timed based entity such as a sequence of pulses) is received by a respective array input 4029 which then applies the signals to one or more rows in respective VMM array 3507. The output from the respective VMM array 3507 is received by column multiplexor 3610, which provides analog signals (such as a voltage, a current, or a timed based entity) over one or more vertical interfaces 3521 or horizontal interfaces 3716 to a respective neuron circuit 3510, which neuron circuit 3510 provides a buffered signal to a device external to 3D VMM system 4000 (such as a processing unit or graphics processing unit), or to another package 3522, through physical I/O 3520 or to array input 4029 of other VMM array 3507 (representing another layer in the artificial neural network).

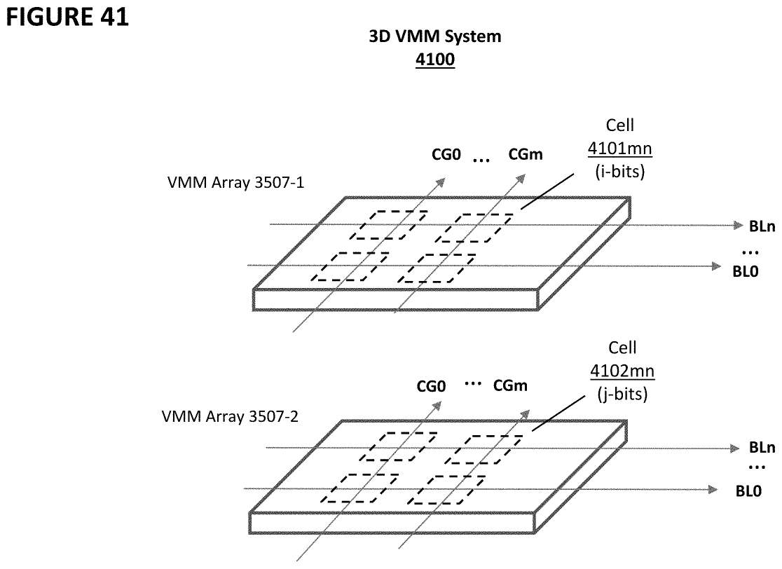

FIGS. 41-44 depict additional detail regarding example configurations of VMM arrays 3507. FIG. 41-44 depict 3D VMM systems 4100, 4200, 4300, and 4400, respectively. Each of 3DD VMM systems 4100, 4200, 4300, and 4400 comprises VMM array 3507-1 on a first die and VMM array 3507-2 on a second die in a common package (not shown). VMM arrays 3507-1 and 3507-2 respectively contain an array of non-volatile memory cells arranged in m+1 rows and n+1 columns. Respective rows are coupled to one of the control gate lines labeled CG0, . . . ,CGm, and respective columns are coupled to one of the bit lines labeled BL0, . . . ,BLn. Cells are located at the intersection of a bit line and a control gate line. For example, cell 4101mn is located in row m and column n and coupled to CGm and BLn in VMM array 3507-1, and cell 4102mn is located in row m and column n and coupled to CGm and BLn in VMM array 3507-2. Because VMM array 3507-1 and 3507-2 are located on different dies, they optionally can be manufactured using different semiconductor processes. Regardless of whether the same or a different semiconductor process is used to manufacture VMM arrays 3507-1 and 3507-2, the cells in VMM array 3507-1 can store a different number of bits than the cells in VMM array 3507-2. For example, the cells in VMM array 3507-1 such as cell 4101mn can store i bits, whereas the cells in VMM array 3507-2 such as cell 4102mn can store j bits, where i and j are integers of different values. For example, i can be 3 (meaning that cells in VMM array 3507-1 respectively store a 3-bit value) and j can be 5 (meaning that cells in VMM array 3507-2 respectively store a 5-bit value).

In FIG. 41, inputs are provided separately to VMM arrays 3507-1 and 3507-2 through the control gate lines, and outputs are obtained separately on the bit lines. FIG. 41 depicts example cells 4101mn and 4102mn. Optionally, the outputs can be combined elsewhere if desired, such as by converting them into digital form using ADC 3516 (shown in previous Figures) and adding them together using digital circuits 3517 (shown in previous Figures).

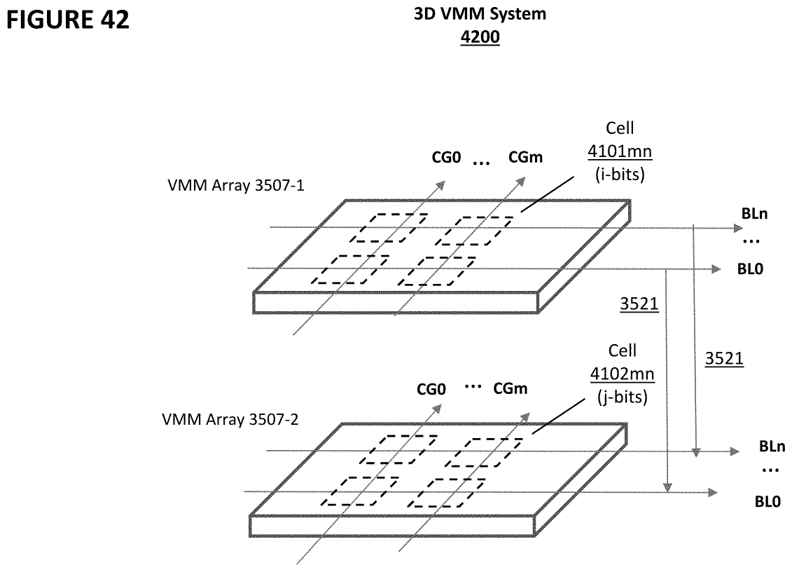

In FIG. 42, inputs are provided separately to VMM arrays 3507-1 and 3507-2 through the control gate lines. The outputs of VMM array 3507-1 are obtained on a first set of bit lines and the outputs of VMM array 3507-2 are obtained on a second set of bit lines, where the first set of bit lines are coupled to the second set of bit lines by respective vertical interfaces 3521 which effectively adds the output signals together in analog form. Optionally, the combined analog output can be digitized elsewhere if desired, such as by converting them into digital form using ADC 3516 (shown in previous Figures).

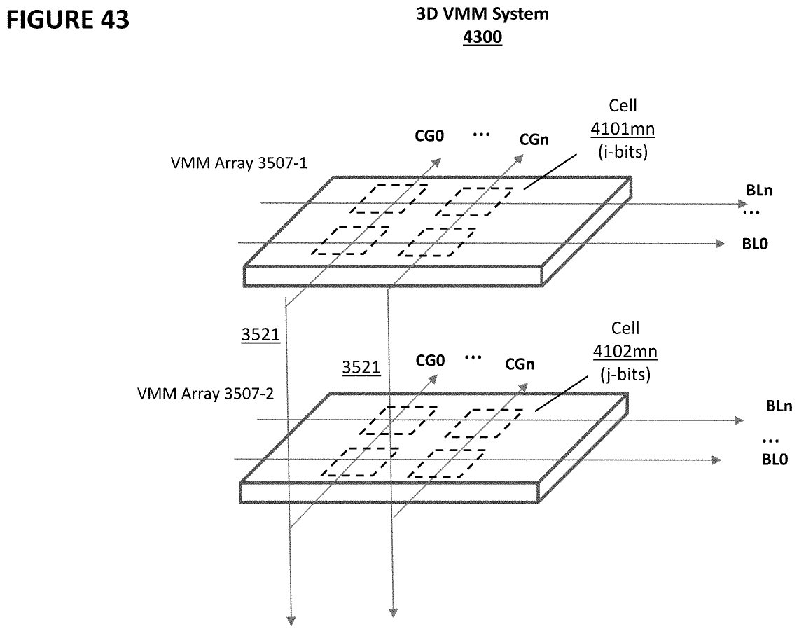

In FIG. 43, inputs are provided through a first set of control gate lines to VMM array 3507-1 and a second set of control gate lines to VMM array 3507-2, wherein the first set of control gate lines are coupled to the second set of control gate lines by respective vertical interfaces 3521, and outputs are obtained separately on the bit lines. Optionally, the outputs can be combined elsewhere if desired, such as by converting them into digital form using ADC 3516 (shown in previous Figures) and adding them together using digital circuits 3517 (shown in previous Figures).

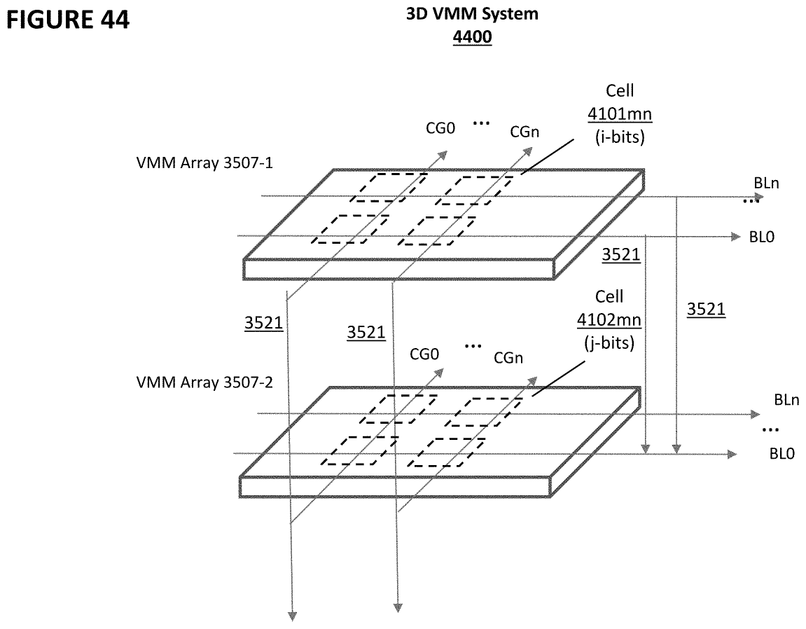

In FIG. 44, inputs are provided in common, through the control gate lines, to VMM arrays 3507-1 and 3507-2 through vertical interfaces 3521. The outputs are obtained on the bit lines, which are combined together through vertical interfaces 3521, which effectively adds the signals together in analog form. Optionally, the combined analog output can be digitized elsewhere if desired, such as by converting them into digital form using ADC 3516 (shown in previous Figures).

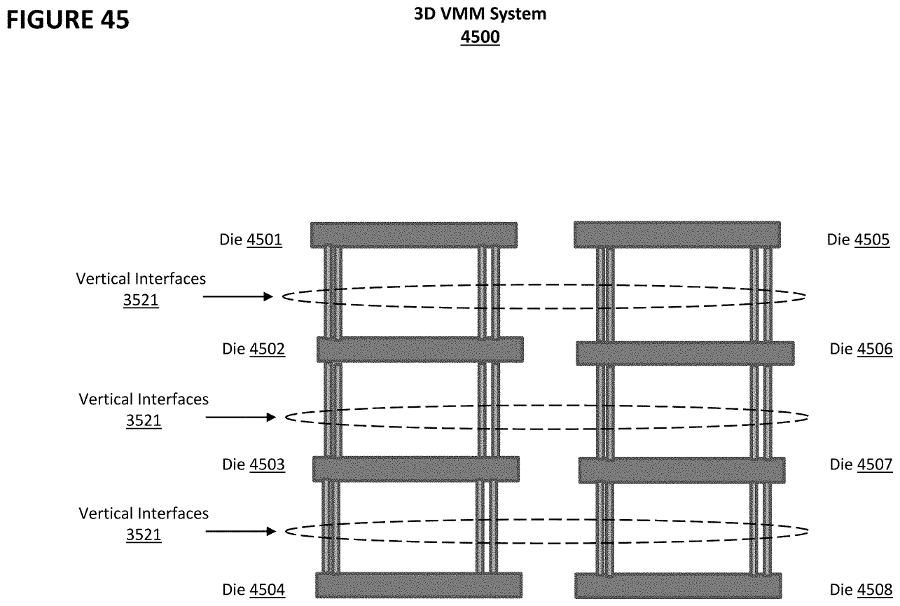

FIGS. 45 to 48 depict examples of structural layout options for dies, vertical interfaces, and horizontal interfaces.

FIG. 45 depicts 3D VMM system 4500, which comprises a first set of dies arranged in a vertical configuration (dies 4501, 4502, 4503, and 4504) and connected by vertical interfaces 3521, and a second set of dies arranged in a vertical configuration (dies 4505, 4506, 4507, and 4508) and connected by vertical interfaces 3521. Here one die can connect to two other dies by respective ones of the vertical interfaces 3521.

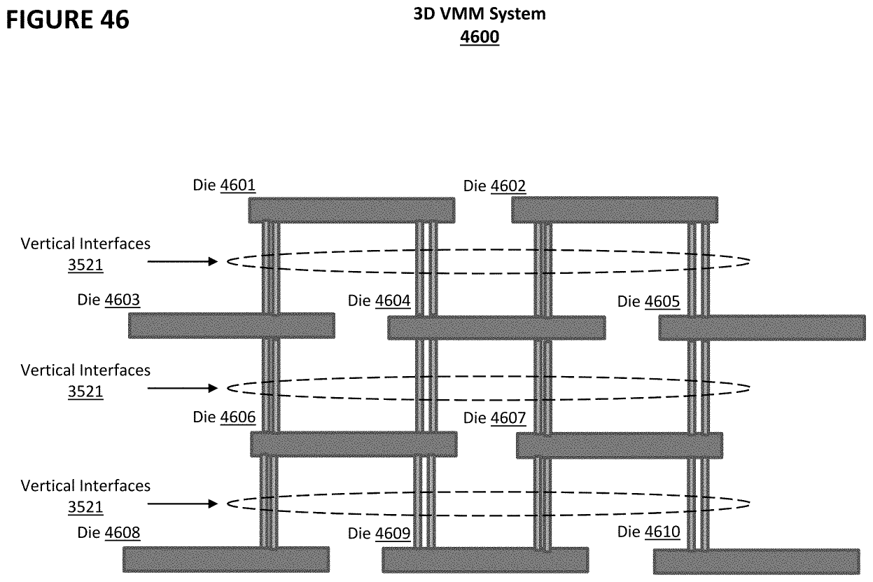

FIG. 46 depicts 3D VMM system 4600, which comprises four levels of dies arranges in a vertically staggered configuration, where the first level comprises dies 4601 and 4602, the second level comprises dies 4603, 4604, and 4605, the third level comprises dies 4606 and 4607, and the fourth level comprises dies 4608, 4609, and 4610. Dies in different levels are connected to dies in a level above, and to dies in a level below, by respective vertical interfaces 3521. Here one die can connect to four other dies by respective ones of the vertical interfaces 3521.

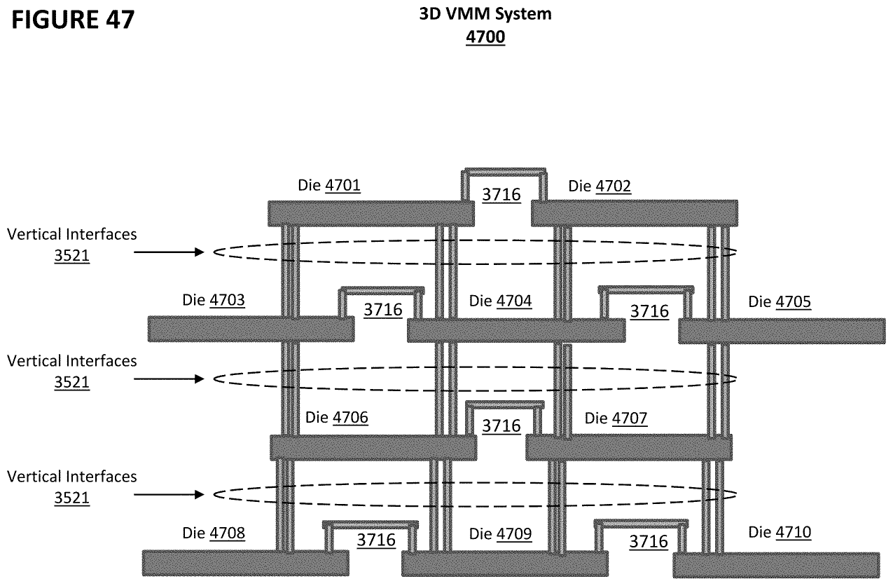

FIG. 47 depicts 3D VMM system 4700, which comprises four levels of dies arranges in a vertically staggered configuration, where the first level comprises dies 4701 and 4702, the second level comprises dies 4703, 4704, and 4705, the third level comprises dies 4706 and 4707, and the fourth level comprises dies 4708, 4709, and 4710. Dies in different levels are connected by respective vertical interfaces 3521, and dies in the same level are connected by respective horizontal interfaces 3716. Here one die can connect to six other dies by respective ones of the vertical interfaces 3521 and by respective ones of the horizontal interfaces 3716.

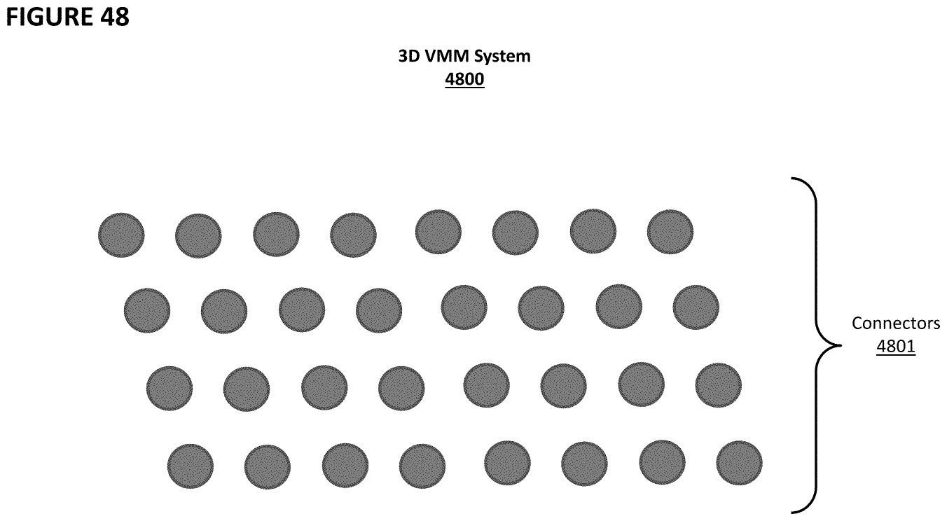

FIG. 48 depicts an example of a physical layout of 3D VMM system 4800, where only connectors 4801 are shown. Connectors 4801 are located in a die and connect to one or more vertical interfaces 3521 and horizontal interfaces 3716. As can be seen, the dies and interfaces can be arranged such that the connectors 4801 are located in a vertically staggered configuration.

### Circuits for Use in 3D VMM Systems

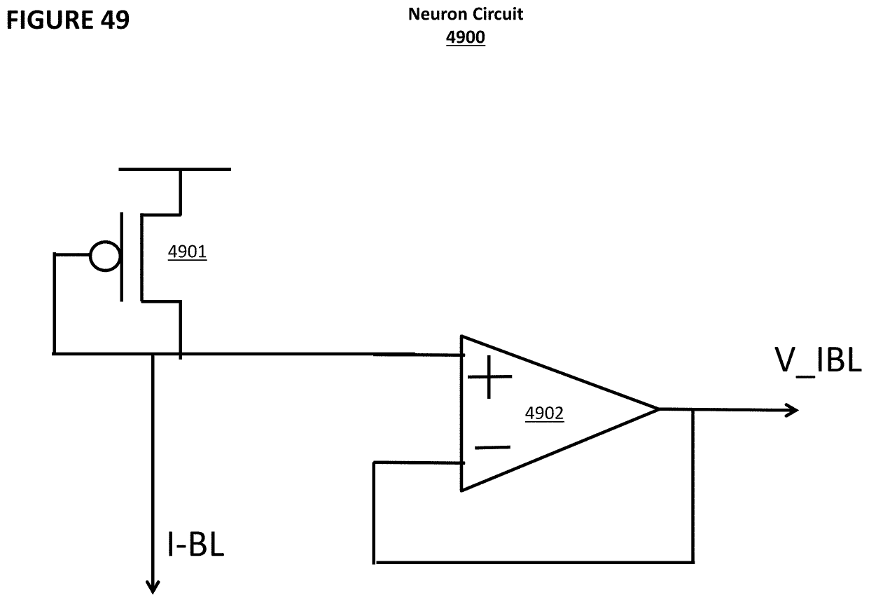

FIGS. 49-55 depicts circuits for use in 3D VMM systems such as those described previously.

FIG. 49 depicts neuron circuit 4900, which can be used in neuron circuit 3510 described previously. Specifically, neuron circuit 3510 may comprise an instance of neuron circuit 4900 for each bit line in VMM array 3507. Neuron circuit 4900 comprises p-channel metal-oxide-semiconductor (PMOS) transistor 4901 and operational amplifier 4902, arranged as shown. One terminal of PMOS transistor 4901 is attached to a voltage source. Another terminal of PMOS transistor 4901 is attached to the gate of PMOS transistor 4910 and to a bit line in VMM array 3507 and to the non-inverting terminal of operational amplifier 4902. The output of operational amplifier 4902 is attached to the inverting input of operational amplifier 4902. The current drawn by the bit line, I-BL, results in a voltage, V_IBL, output from operational amplifier 4902. Operational amplifier 4902 acts as a buffer, and V_IBL will maintain its level despite the load it might be attached to. For example, if V_IBL is provided to a vertical interface 3521, the vertical interface 3521 might have a parasitic capacitance or parasitic current. Neuron circuit 4900 will maintain the output voltage, V_IBL, despite the variation of load. This is thus a neuron current buffer circuit. In another embodiment the neuron current (bitline current) can be scaled up or down by a current mirror before going into this circuit.

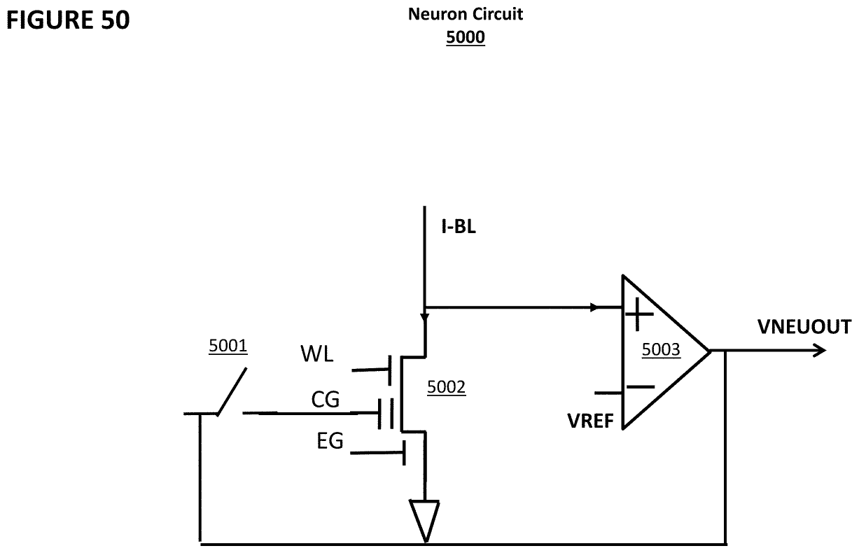

FIG. 50 depicts neuron circuit 5000, which can be used in neuron circuit 3510 described previously. Specifically, neuron circuit 3510 may comprise an instance of neuron circuit 5000 for each bit line in VMM array 3507. Neuron circuit 5000 comprises controlled switch 5001, reference memory cell 5002, and operational amplifier 5003, arranged as shown. The current drawn by the bit line, I-BL, results in a certain voltage at the non-inverting terminal of operational amplifier 5003. When switch 5001 is closed, feedback from the output of operational amplifier 5003, VNEUOUT, is provided to the control gate terminal of reference memory cell 5002. Due to the inherent characteristics of an operational amplifier, operation amplifier 5003 will modify output voltage VNEUOUT until the voltage on its non-inverting terminal equals the voltage, VREF, on its inverting terminal. It does this through the feedback to the control gate terminal of reference memory cell 5002. Neuron circuit 5000 will maintain the output voltage, VNEUOUT, despite the load of the parasitic capacitance that may be receiving that voltage, such as a vertical interface 3521. Neuron circuit 5000 converts the neuron current I-BL into a voltage, VNEUOUT, using memory cell 5002. It is therefore a memory cell based current-to-voltage converter using an operational amplifier with feedback.

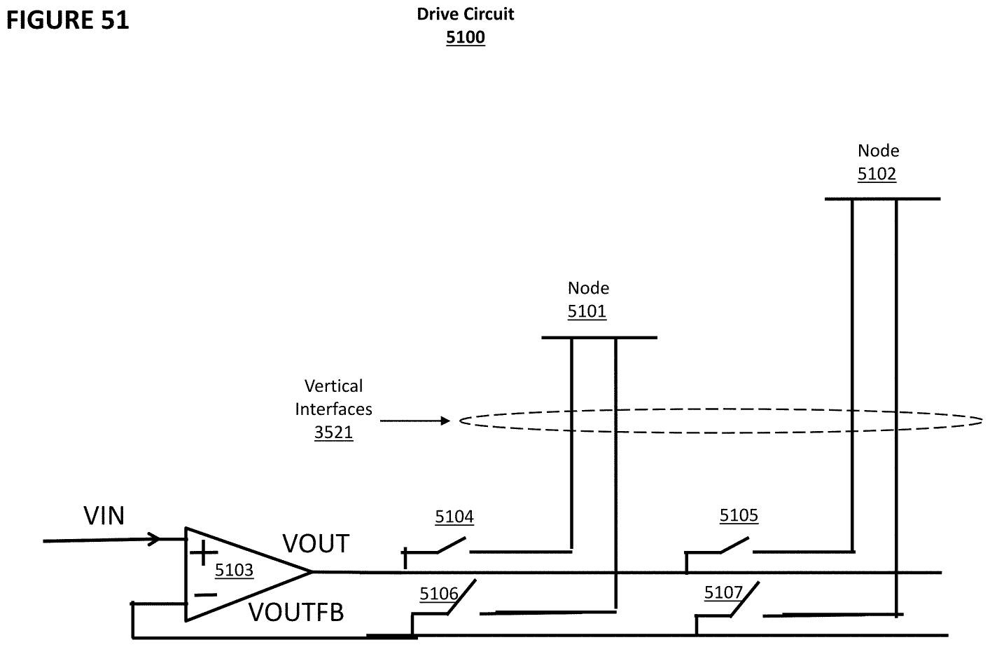

FIG. 51 depicts force and sense (F/S) drive circuit 5100 (where the forcing is caused by operational amplifier 5103 with input VIN at positive terminal and the sensing occurs at target nodes, node 5101 or 5102, with voltage at target nodes feedback to the negative terminal of the amplifier, and this voltage is made equal to input voltage VIN by the action the amplifier), which can be used in neuron circuit 3510 or elsewhere to accurately deliver voltage output of the neuron over varying loads. F/S drive circuit 5100 comprises operational amplifier 5103 and controlled switches 5104, 5105, 5106, and 5107, arranged as shown. Vin is received at the non-inverting input of operational amplifier 5103, and the output of operational amplifier 5103 is termed VOUT. Switches 5104 and 5106, when closed, respectively connect the output of operational amplifier 5103 and the inverting input of operational amplifier 5103, as VOUTFB, to node 5101 in a first die through vertical interfaces 3521. Switches 5105 and 5107, when closed, respectively connect the output of operational amplifier 5103 and the inverting input of operational amplifier 5103, as VOUTFB, to node 5102 in a second die through vertical interfaces 3521. Drive circuit 5100 provides an accurate voltage, VOUT, to node 5101 and node 5102 despite any loading effect caused by the vertical interfaces 3521 or by the first and second die. This is due to sense node (driven node) 5101 or 5102 being fed back to the inverting input of operational amplifier 5103.

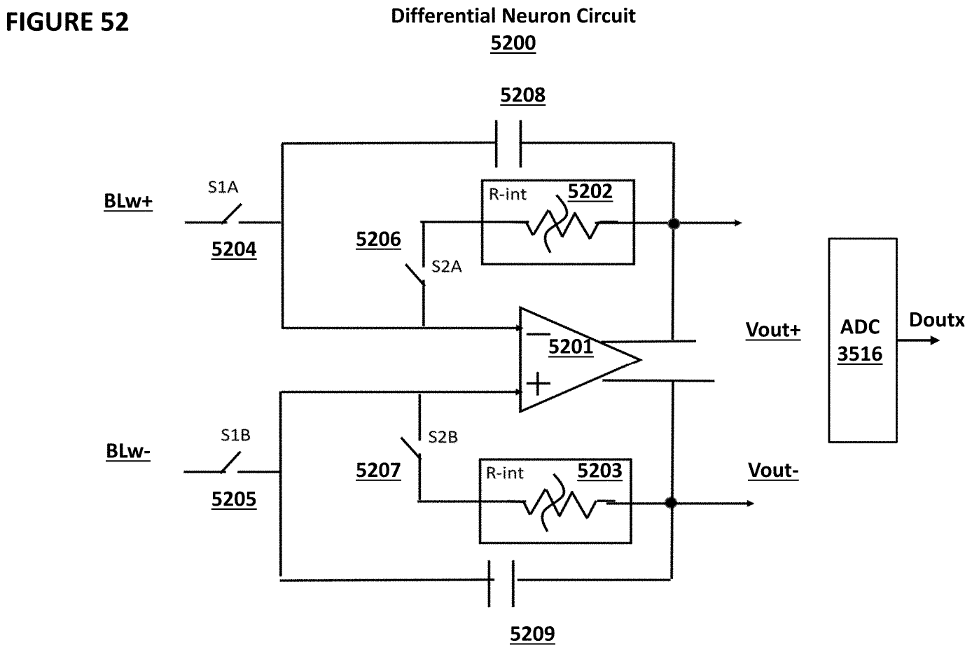

FIG. 52 depicts differential neuron circuit 5200, which can be used in neuron circuit 3510 described previously. Specifically, neuron circuit 3510 may comprise an instance of differential neuron circuit 5200 for each pair of differential bit lines in VMM array 3507, such as in the instance where one column stores W+ values and another column stores W− values, and each pair of W+ and W− represents a stored weight.

Differential neuron circuit 5200 comprises operational amplifier 5201; variable integrating resistors 5202 and 5203; controlled switches 5204, 5205, 5206, and 5207; and sample and hold (and/or integrating) capacitors 5208 and 5209, configured as shown. Differential neuron circuit 5200 receives differential current BLw+ from a W+ bit line and BLw− from a W-bit line and outputs voltages Vout+ and Vout−, respectively. The output voltage Vout+=(BLw+)*R and Vout−=(BLw−)*R, with variable integrating resistors 5202 and 5203 each having value equal to R. Capacitors 5208 and 5209 serves as respective sample and hold (S/H) capacitors to hold the output voltage once the resistors 5202 and 5203 are removed from the circuit by opening controlled switches 5206, 5207 and the input current is shut off by opening controlled switches 5204, 5205. A control circuit (not shown) controls the opening and closing of switches 5204, 5205, 5206 and 5207 to provide an integration time. Optionally, differential output voltages Vout+ and Vout− can be input to ADC 3516, which converts differential output voltages Vout+ and Vout− into a set of digital output bits, Doutx. Optionally the circuit can use the capacitors 5208 and 5209 as integrating capacitors to integrate the neuron currents to convert the current into a voltage, Vout=Time*Ineuron/Capacitance. The neuron scaling is provided by variable resistors 5292 and 5203 or variable integrating time and/or variable capacitance in case of using integrating capacitor approach.

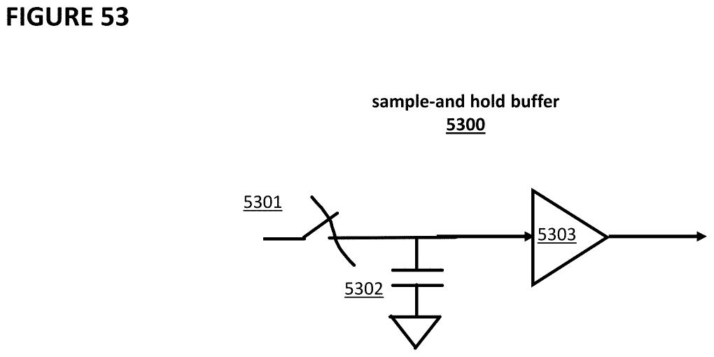

FIG. 53 depicts sample-and-hold buffer 5300, which can be used in input circuit 3514 described previously. Specifically, input circuit 3514 may comprise an instance of sample-and-hold buffer 5300 for each row in VMM array 3507. Sample-and-hold buffer 5300 comprises controlled switch 5301, capacitor 5302, and buffer 5303. Buffer 5303 can be a unity buffer formed from an operational amplifier. During operation, switch 5301 is closed, which allows an analog value (for example from a DAC 3515) to be stored in capacitor 5302. That value can then be output from buffer 5303, which drives a row input of VMM array 3507. Capacitor 5302 can be an actual capacitor, or it can be an intrinsic capacitor found in a wire, for example.

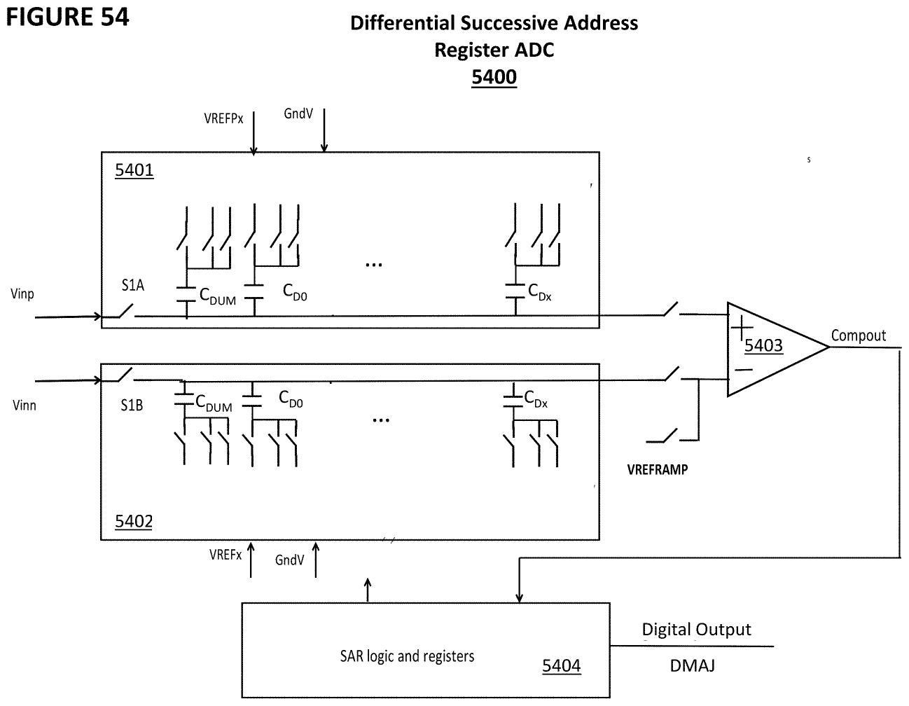

FIG. 54 depicts differential successive address register (SAR) analog-to-digital converter (ADC) 5400, which can be used in ADC 3516 described previously.

Differential successive address register analog-to-digital converter 5400 converts an analog input or differential analog input into a digital output using a binary search through all possible quantization levels to identify the appropriate digital output.

Differential successive address register analog-to-digital converter 5400 comprises binary capacitive digital-to-analog converter (CDAC) 5401, binary CDAC 5402 (complementary to CDAC 5401), comparator 5403, and SAR logic and registers 5404.

Differential successive address register analog-to-digital converter 5400 receives a differential current input, Vinp and Vinn. SAR logic and registers 5404 cycle through all possible digital bit combinations, which in turn control switches in CDAC 5401 and 5402 to couple voltage sources to capacitors. When the output of comparator 5403 flips, then the digital bit combination in SAR logic and registers 5404 is output as Digital Output. Optionally, SAR logic and registers 5404 generates an additional 1-bit digital output, DMAJ, in Digital Outputs which is a “1” if a majority of the bits in the digital value are a “1”, and a “0” if a majority of the bits in the corresponding digital value are not “1.”

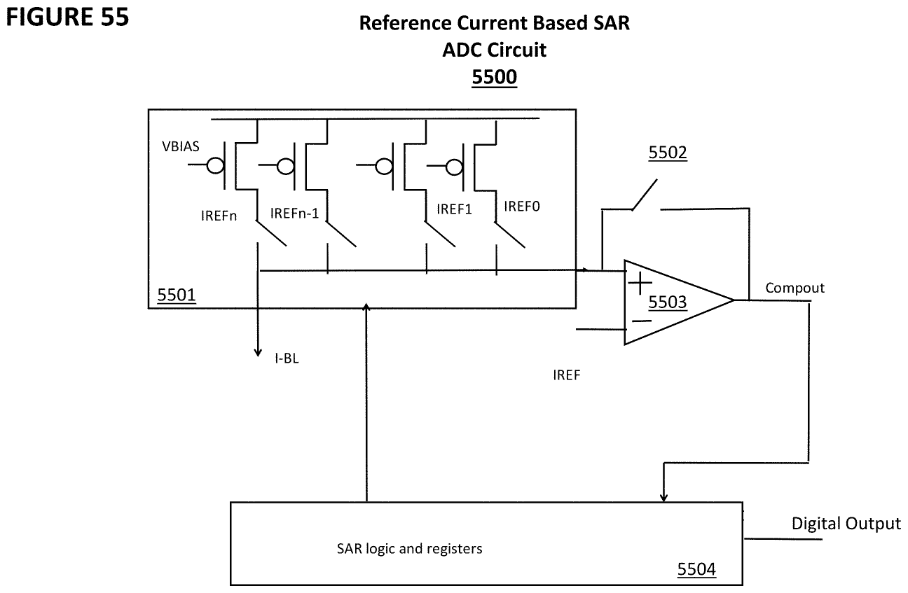

FIG. 55 depicts reference current based SAR ADC circuit 5500, which can be used in ADC 3516 described previously. Specifically, ADC 3516 may comprise one or more instances of ADC circuit 5500, where ADC circuit 5500 converts a current, I-BL, into a digital value, Digital Output. ADC circuit 5500 comprises binary current block 5501, switch 5502, comparator 5503, and SAR logic and registers 5504. The binary current block 5501 provides binary reference currents to be compared against the bitline input current in a binary search fashion, meaning from MSB (most significant bit) to LSB (least significant bit) search.

It should be noted that, as used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

What is claimed is:

1. A three-dimensional integrated circuit for use in an artificial neural network comprising:
a first die comprising a first vector by matrix multiplication array and a first input multiplexor, the first die located on a first vertical layer;
a second die comprising an input circuit, the second die located on a second vertical layer different than the first vertical layer; and
one or more vertical interfaces coupling the first die and the second die;
wherein during a read operation, the input circuit provides an input signal to the first input multiplexor over at least one of the one or more vertical interfaces, the first input multiplexor applies the input signal to one or more rows in the first vector by matrix multiplication array, and the first vector by matrix multiplication array generates an output.

2. The three-dimensional integrated circuit of claim 1, wherein the second die comprises a digital-to-analog converter for converting a digital input into an analog input provided to the input circuit as the input signal.

3. The three-dimensional integrated circuit of claim 1, wherein the first die comprises a neuron circuit for buffering the output.

4. The three-dimensional integrated circuit of claim 1, wherein the first die comprises a column multiplexor for sending the output to the second die or a third die over at least one of the one or more vertical interfaces.

5. The three-dimensional integrated circuit of claim 1, comprising:
a third die comprising an analog-to-digital converter to convert the output from the first die into a digital output, the third die located on a third vertical layer different than the first vertical layer and the second vertical layer.

6. The three-dimensional integrated circuit of claim 5, comprising:
a fourth die comprising a high voltage generator, analog circuitry, and a temperature compensation circuit, the fourth die located on a fourth vertical layer different than the first vertical layer, the second vertical layer, and the third vertical layer.

7. The three-dimensional integrated circuit of claim 6, comprising:
a fifth die comprising a second vector by matrix multiplication array, a second input multiplexor, a high voltage decoder, and a neuron circuit, the fifth die located on a fifth vertical layer different than the first vertical layer, the second vertical layer, the third vertical layer, and the fourth vertical layer.

8. The three-dimensional integrated circuit of claim 1 comprising:
a third die comprising a second vector by matrix multiplication array and a second input multiplexor, the third die located on the first vertical layer.

9. The three-dimensional integrated circuit of claim 1, wherein the vector by matrix multiplication array comprises a plurality of non-volatile memory cells.

10. The three-dimensional integrated circuit of claim 9, wherein the plurality of non-volatile memory cells comprises stacked gate flash memory cells.

11. The three-dimensional integrated circuit of claim 9, wherein the plurality of non-volatile memory cells comprises split gate flash memory cells.

12. A method comprising:
providing over one or more vertical interfaces, by an input circuit located on a first die, an input signal to an input multiplexor located on a second die;
applying, by the input multiplexor, the input signal to one or more rows in a neural network array; and
generating, by the neural network array, an output;
wherein the first die and the second die are located on different vertical layers.

13. The method of claim 12, wherein the neural network array comprises a plurality of non-volatile memory cells.

14. The method of claim 13, wherein the plurality of non-volatile memory cells comprises stacked gate flash memory cells.

15. The method of claim 13, wherein the plurality of non-volatile memory cells comprises split gate flash memory cells.

16. An apparatus comprising:
a first die comprising a first vector by matrix multiplication array comprising a plurality of non-volatile memory cells arranged in rows and columns, the first die located on a first vertical layer;
a second die comprising a second vector by matrix multiplication array comprising a plurality of non-volatile memory cells arranged in rows and columns, the second die located on a second vertical layer different than the first vertical layer; and
one or more vertical interfaces coupling the first die and the second die;
wherein during a program operation, one or more non-volatile memory cells in the first array are capable to store i bits and one or more non-volatile memory cells in the second array are capable to store j bits, where i≠j.

17. The apparatus of claim 16, wherein the first die was manufactured according to a first semiconductor process and the second die was manufactured according to a second semiconductor process different than the first semiconductor process.

18. The apparatus of claim 16, comprising:
a first set of bit lines coupled to the first vector by matrix multiplication array; and
a second set of bit lines, different than the first set of bit lines, coupled to the second vector by matrix multiplication array.

19. The apparatus of claim 18, comprising:
a first set of control gate lines coupled to the first vector by matrix multiplication array; and
a second set of control gate lines, different than the first set of control gate lines, coupled to the second vector by matrix multiplication array.

20. The apparatus of claim 19, wherein the first set of control gate lines are coupled to the second set of control gate lines by a respective vertical interface.

21. The apparatus of claim 18, wherein the first set of bit lines are coupled to the second set of bit lines by a respective vertical interface.

22. The apparatus of claim 21, comprising:
a first set of control gate lines coupled to the first vector by matrix multiplication array; and
a second set of control gate lines coupled to the second vector by matrix multiplication array.

23. The apparatus of claim 22, wherein the first set of control gate lines are coupled to the second set of control gate lines by a respective vertical interface.

24. The apparatus of claim 16, wherein the plurality of non-volatile memory cells in the first die and the plurality of non-volatile memory cells in the second die respectively comprise stacked gate flash memory cells.

25. The apparatus of claim 16, wherein the plurality of non-volatile memory cells in the first die and the plurality of non-volatile memory cells in the second die respectively comprise split gate flash memory cells.

26. A method comprising:
storing, in a first neural network array in a first die, a value comprising i bits in a non-volatile memory cell; and
storing, in a second neural network array in a second die, a value comprising i bits in a non-volatile memory cell, where i≠y;
wherein the first die and the second die are located on different vertical layers.

27. An apparatus comprising:
a first die comprising a first vector by matrix multiplication array comprising a respective plurality of non-volatile memory cells arranged in rows and columns, the first die located on a first vertical layer;
a second die comprising a second vector by matrix multiplication array comprising a respective plurality of non-volatile memory cells arranged in rows and columns, the second die located on a second vertical layer different than the first layer; and
a third die comprising one or more of a digital-to-analog-converter and an analog-to-digital converter.

28. The apparatus of claim 27, wherein the analog-to-digital converter is a capacitor based successive approximation register analog-to-digital converter.

29. The apparatus of claim 27, wherein the analog-to-digital converter is a reference current based successive approximation register analog-to-digital converter.

30. The apparatus of claim 27, wherein the respective plurality of non-volatile memory cells in the first and second vector by matrix multiplication arrays comprise stacked gate flash memory cells.

31. The apparatus of claim 27, wherein the respective plurality of non-volatile memory cells in the first and second vector by matrix multiplication arrays comprise split gate flash memory cells.

32. An apparatus comprising:
a first die comprising a first vector by matrix multiplication array comprising a plurality of non-volatile memory cells arranged in rows and columns, the first die located on a first vertical layer;
a second die comprising a second vector by matrix multiplication array comprising a plurality of non-volatile memory cells arranged in rows and columns, the second die located on a second vertical layer different than the first vertical layer; and
a third die comprising a neuron circuit.

33. The apparatus of claim 32, wherein the neuron circuit comprises:
a p-channel metal-oxide-semiconductor transistor comprising a first terminal coupled to a voltage source, a gate, and a second terminal coupled to the gate and to a neuron; and
an operation amplifier comprising a non-inverting input coupled to the second terminal and the gate of the p-channel metal-oxide-semiconductor transistor, an inverting input, and an output coupled to the inverting input to generate a voltage output in response to current from the neuron.

34. The apparatus of claim 32, wherein the neuron circuit comprises:
a switch;
a reference memory cell comprising a bit line terminal coupled to a neuron, a source line terminal, and a control gate terminal; and
an operational amplifier comprising an inverting input coupled to a reference voltage, a non-inverting input coupled to the bit line terminal of the reference memory cell, and an output switchably coupled to the control gate terminal of the reference memory cell through the switch.

35. The apparatus of claim 32, wherein the neuron circuit comprises:
an operational amplifier comprising an inverting input, a non-inverting input, and first output coupled to a first output node and a second output coupled to a second output node;
a first variable integrating resistor switchably coupled between the first output node and the inverting input of the operational amplifier through a first switch;
a second variable integrating resistor switchably coupled between the second output node and the non-inverting input of the operational amplifier through a second switch;
a first capacitor switchably coupled between a first input current from a bit line through a third switch and the first output node; and
a second capacitor switchably coupled between a second input current from a bit line through a fourth switch and the second output node.

36. The apparatus of claim 35, wherein the first input current and the second input current are a differential current signal, and the first output node and the second output node contain a differential voltage signal.

37. The apparatus of claim 36, wherein the first input current is received from a W+ bit line and the second input current is received from a W− bit line.

38. The apparatus of claim 36, comprising an analog-to-digital converter to covert the differential voltage signal into a set of digital output bits.

39. The apparatus of claim 32, wherein the plurality of non-volatile memory cells in the first and second vector by matrix multiplication arrays comprise stacked gate flash memory cells.

40. The apparatus of claim 32, wherein the plurality of non-volatile memory cells in the first and second vector by matrix multiplication arrays comprise split gate flash memory cells.

41. An apparatus comprising:
a first die comprising a first vector by matrix multiplication array comprising a respective plurality of non-volatile memory cells arranged in rows and columns, the first die located on a first vertical layer;
a second die comprising a second vector by matrix multiplication array comprising a respective plurality of non-volatile memory cells arranged in rows and columns, the second die located on a second vertical layer different than the first vertical layer; and
a third die comprising digital circuits comprising one or more of a micro-controller, digital logic, or a single instruction multiple data processor.

42. The apparatus of claim 41, wherein the third die comprises a digital accelerator.

43. The apparatus of claim 41, wherein the third die comprises a static random access memory.

44. The apparatus of claim 41, wherein the third die comprises physical input/output connections.

45. The apparatus of claim 41, wherein the third die comprises registers.

46. The apparatus of claim 41, wherein the respective plurality of non-volatile memory cells in the first vector by matrix multiplication array and the respective plurality of non-volatile memory cells in the second vector by matrix multiplication array comprise stacked gate flash memory cells.

47. The apparatus of claim 41, wherein the respective plurality of non-volatile memory cells in the first vector by matrix multiplication array and the respective plurality of non-volatile memory cells in the second vector by matrix multiplication array comprise split gate flash memory cells.

48. An apparatus comprising:
a first vertical layer comprising a first vector by matrix multiplication array comprising a respective plurality of non-volatile memory cells arranged in rows and columns and a second vector by matrix multiplication array comprising a respective plurality of non-volatile memory cells arranged in rows and columns;
one or more respective horizontal interfaces coupling the first vector by matrix multiplication array and the second vector by matrix multiplication array;
a second vertical layer comprising a third vector by matrix multiplication array comprising a respective plurality of non-volatile memory cells arranged in rows and columns and a fourth vector by matrix multiplication array comprising a respective plurality of non-volatile memory cells arranged in rows and columns; and
one or more respective horizontal interfaces coupling the third vector by matrix multiplication array and the fourth vector by matrix multiplication array.

49. The apparatus of claim 48, wherein the first vector by matrix multiplication array is located on a first die, the second vector by matrix multiplication array is located on a second die, the third vector by matrix multiplication array is located on a third die, and the fourth vector by matrix multiplication array is located on a fourth die.

50. The apparatus of claim 49, wherein the first die and the third die are vertically aligned and the second die and the fourth die are vertically aligned.

51. The apparatus of claim 49, wherein the first die and second die are vertically staggered with the third die and the fourth die.

52. The apparatus of claim 48, wherein the respective plurality of non-volatile memory cells in the first, second, third, and fourth vector by matrix multiplication arrays comprise stacked gate flash memory cells.

53. The apparatus of claim 48, wherein the respective plurality of non-volatile memory cells in the first, second, third, and fourth vector by matrix multiplication arrays comprise split gate flash memory cells.
